(19) United States
(12) Patent Application Publication
(10) Pub. No.: US 2025/0039430 A1
(43) Pub. Date: Jan. 30, 2025

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Mehdi SALEHIFAR, Los Angeles, CA (US); Yuwen HE, Los Angeles, CA (US); Kai ZHANG, Los Angeles, CA (US); Na ZHANG, Beijing (CN); Li ZHANG, Los Angeles, CA (US)

(21) Appl. No.: 18/915,045

(22) Filed: Oct. 14, 2024

Related U.S. Application Data
(63) Continuation of application No. PCT/CN2023/087039, filed on Apr. 7, 2023.

(30) Foreign Application Priority Data
Apr. 12, 2022 (WO) PCT/CN2022/086304

(51) Int. Cl. H04N 19/513; H04N 19/176

(52) U.S. Cl. CPC H04N 19/513; H04N 19/176

(57) ABSTRACT

The present disclosure provides a solution for video processing. A method for video processing comprises: selecting, for a conversion between a current video block of a video and a bitstream of the video, a target scheme from a plurality of candidate schemes for adjusting a merge candidate for the current video block; and performing the conversion based on the target scheme, wherein the plurality of candidate schemes comprise at least one of a first set of candidate schemes and a second set of candidate schemes, in each of the first set of candidate schemes, a first motion vector (MV) of the merge candidate is adjusted with a first motion vector difference (MVD), and a second MV of the merge candidate is kept unadjusted, in each of the second set of candidate schemes, the second MV is adjusted with a second MVD, and the first MV is kept unadjusted.

### CROSS REFERENCE

This application is a continuation of International Application No. PCT/CN2023/087039, filed on Apr. 7, 2023, which claims the benefit of International Application No. PCT/CN2022/086304, filed on Apr. 12, 2022. The entire contents of these applications are hereby incorporated by reference in their entireties.

### FIELDS

Embodiments of the present disclosure relates generally to video processing techniques, and more particularly, to merge mode with motion vector difference (MMVD) based coding.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of video coding techniques is generally expected to be further improved.

### SUMMARY

Embodiments of the present disclosure provide a solution for video processing.

In a first aspect, a method for video processing is proposed. The method comprises: selecting, for a conversion between a current video block of a video and a bitstream of the video, a target scheme from a plurality of candidate schemes for adjusting a merge candidate for the current video block; and performing the conversion based on the target scheme, wherein the plurality of candidate schemes comprise at least one of a first set of candidate schemes and a second set of candidate schemes, in each of the first set of candidate schemes, a first motion vector (MV) of the merge candidate is adjusted with a first motion vector difference (MVD), and a second MV of the merge candidate is kept unadjusted, in each of the second set of candidate schemes, the second MV is adjusted with a second MVD, and the first MV is kept unadjusted.

According to the method in accordance with the first aspect of the present disclosure, one of the first and second MVs for bi-prediction of the current video block may be adjusted while the another one is kept unadjusted. In other words, the adjustment of the two MVs for bi-prediction of the current video block is decoupled. Compared with the conventional solution where the adjustment of the two MVs for bi-prediction is coupled with each other, the proposed method can advantageously make the adjustment of the merge candidate more flexible and thus improve coding efficiency and coding quality.

In a second aspect, another method for video processing is proposed. The method comprises: obtaining, for a conversion between a current video block of a video and a bitstream of the video, the number of one or more merge candidates for the current video block that are adjusted with at least one MVD, the number of the one or more merge candidates being dependent on coding information of one or more further video blocks of the video which are different from the current video block; and performing the conversion based on the number of the one or more merge candidates.

According to the method in accordance with the second aspect of the present disclosure, the number of one or more merge candidates for the current video block that are adjusted with at least one MVD is variable rather than being fixed. Compared with the conventional solution where this number is fixed, the proposed method can advantageously make an MMVD-based coding tool more flexible and thus improve coding efficiency and coding quality.

In a third aspect, an apparatus for video processing is proposed. The apparatus comprises a processor and a non-transitory memory with instructions thereon. The instructions upon execution by the processor, cause the processor to perform a method in accordance with the first and second aspects of the present disclosure.

In a fourth aspect, a non-transitory computer-readable storage medium is proposed. The non-transitory computer-readable storage medium stores instructions that cause a processor to perform a method in accordance with the first and second aspects of the present disclosure.

In a fifth aspect, another non-transitory computer-readable recording medium is proposed. The non-transitory computer-readable recording medium stores a bitstream of a video which is generated by a method performed by an apparatus for video processing. The method comprises: selecting a target scheme from a plurality of candidate schemes for adjusting a merge candidate for a current video block of the video; and generating the bitstream based on the target scheme, wherein the plurality of candidate schemes comprise at least one of a first set of candidate schemes and a second set of candidate schemes, in each of the first set of candidate schemes, a first motion vector (MV) of the merge candidate is adjusted with a first motion vector difference (MVD), and a second MV of the merge candidate is kept unadjusted, in each of the second set of candidate schemes, the second MV is adjusted with a second MVD, and the first MV is kept unadjusted.

In a sixth aspect, a method for storing a bitstream of a video is proposed. The method comprises: selecting a target scheme from a plurality of candidate schemes for adjusting a merge candidate for a current video block of the video; generating the bitstream based on the target scheme; and storing the bitstream in a non-transitory computer-readable recording medium, wherein the plurality of candidate schemes comprise at least one of a first set of candidate schemes and a second set of candidate schemes, in each of the first set of candidate schemes, a first motion vector (MV) of the merge candidate is adjusted with a first motion vector difference (MVD), and a second MV of the merge candidate is kept unadjusted, in each of the second set of candidate schemes, the second MV is adjusted with a second MVD, and the first MV is kept unadjusted.

In a seventh aspect, another non-transitory computer-readable recording medium is proposed. The non-transitory computer-readable recording medium stores a bitstream of a video which is generated by a method performed by an apparatus for video processing. The method comprises: obtaining the number of one or more merge candidates for a current video block of the video that are adjusted with at least one MVD, the number of the one or more merge candidates being dependent on coding information of one or more further video blocks of the video which are different from the current video block; and generating the bitstream based on the number of the one or more merge candidates.

In an eighth aspect, a method for storing a bitstream of a video is proposed. The method comprises: obtaining the number of one or more merge candidates for a current video block of the video that are adjusted with at least one MVD, the number of the one or more merge candidates being dependent on coding information of one or more further video blocks of the video which are different from the current video block; generating the bitstream based on the number of the one or more merge candidates; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram of an example video coding system in accordance with some embodiments of the present disclosure;

FIG. 2 illustrates a block diagram of an example video encoder in accordance with some embodiments of the present disclosure;

FIG. 3 illustrates a block diagram of an example video decoder in accordance with some embodiments of the present disclosure;

FIG. 4 illustrates a schematic diagram of MMVD search process;

FIG. 5 illustrates a schematic diagram of MMVD search point;

FIG. 6 illustrates a schematic diagram of simplified affine motion model;

FIG. 7 illustrates a schematic diagram of affine MVF per sub-block;

FIG. 8 illustrates a schematic diagram of distance index and distance offset mapping;

FIG. 9A illustrates an example implementation of adding diagonal angles;

FIG. 9B illustrates another example implementation of adding diagonal angles;

FIG. 9C illustrates a further example implementation of adding diagonal angles;

FIG. 10A illustrates an example implementation of adding diagonal angles with exact similar distance around a circle;

FIG. 10B illustrates another example implementation of adding diagonal angles with exact similar distance around a circle;

FIG. 11 illustrates some example implementations of adding arbitrary combination of steps and angles asymmetrically;

FIG. 12 illustrates some example implementations of removing every other distance offset;

FIG. 13 illustrates a schematic diagram of proposed MV based dependent direction offset;

FIG. 14 illustrates template and reference samples of the template for block with sub-block motion;

FIG. 15 illustrates template and reference samples of the template for full block;

FIG. 16 illustrates neighbor positions for the current block;

FIG. 17 illustrates a flowchart of a method for video processing in accordance with some embodiments of the present disclosure;

FIG. 18 illustrates a flowchart of another method for video processing in accordance with some embodiments of the present disclosure; and

FIG. 19 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

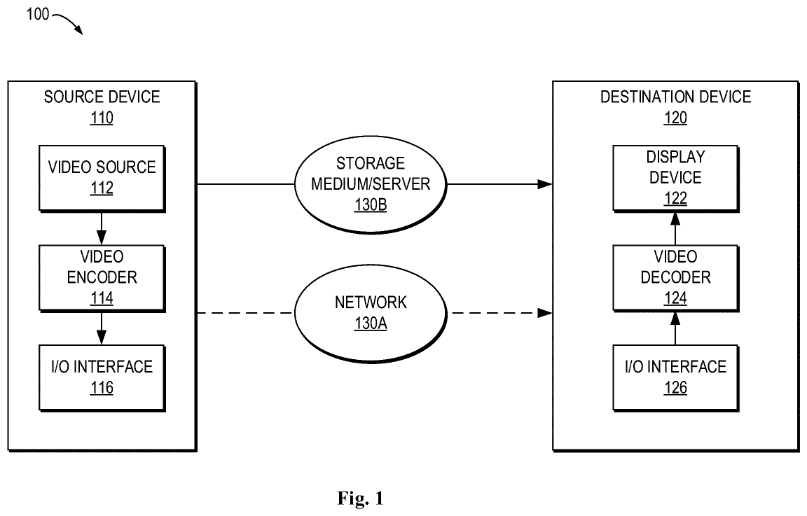

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

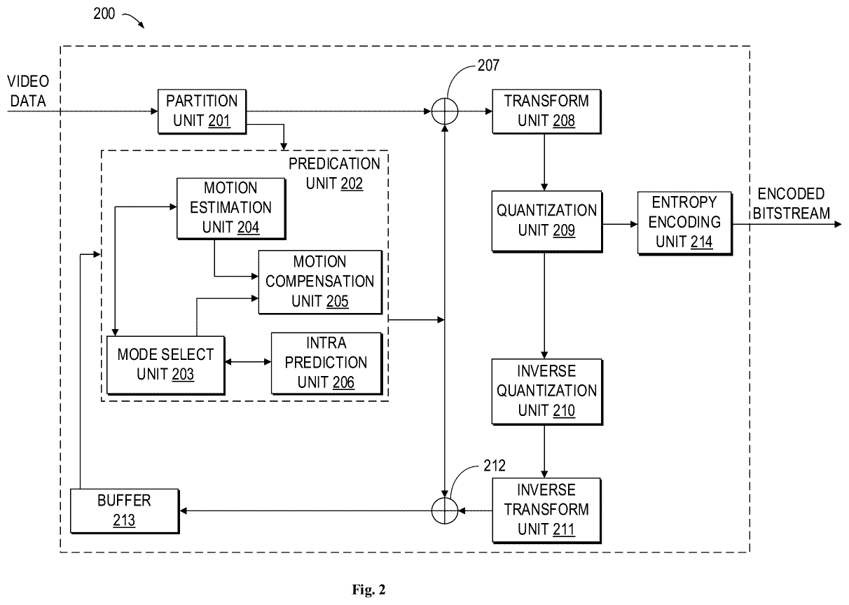

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a prediction unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the prediction unit 202 may include an intra block copy (IBC) unit. The IBC unit may perform prediction in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter prediction (CIIP) mode in which the prediction is based on an inter prediction signal and an intra prediction signal. The mode select unit 203 may also select a resolution for a motion vector (e.g., a sub-pixel or integer pixel precision) for the block in the case of inter-prediction.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector prediction (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the prediction unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

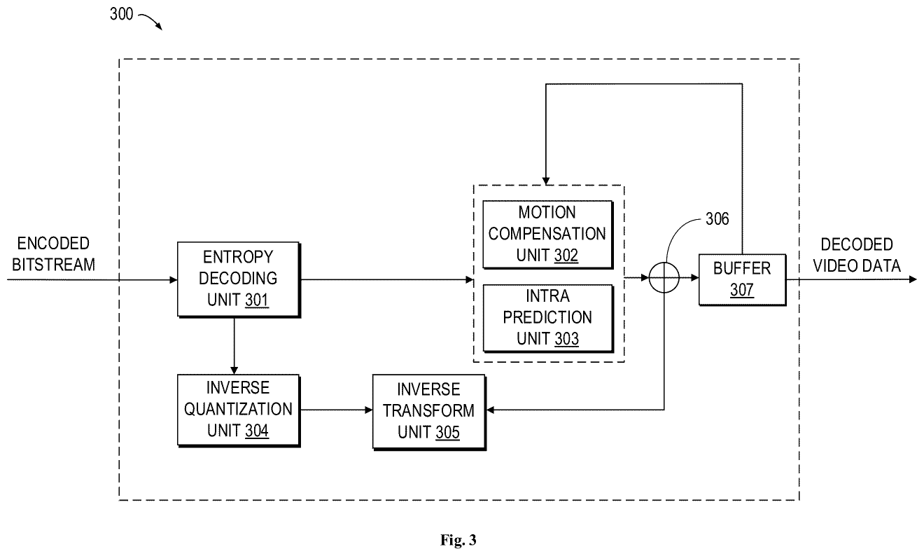

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra prediction and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. BRIEF SUMMARY

This disclosure is related to video/image coding technologies. Specifically, it is related to MMVD. It may be applied to the existing video coding standard like HEVC, VVC, or the next generation video coding standard like beyond VVC exploration such as ECM. It may also be applicable to future video coding standards or video codec.

### 2. INTRODUCTION

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. As of July 2020, it has also finalized the Versatile Video Coding (VVC) standard, aiming at yet another 50% bit-rate reduction and providing a range of additional functionalities. After finalizing VVC, activity for beyond VVC has started. A description of the additional tools on top of the VVC has been summarized, and its reference SW is named as ECM.

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index. A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU. A prediction for MV called MVP will be subtracted from MV, to get MV difference (MVD). MVD have horizonal (MVx) and vertical (MVy) components which will be coded separately. For each MVx and MVy the signs coded independently in bypass mode. |MVx| and |MVy| also coded independently.

2.1 Merge with Motion Vector Difference (MMVD)

MMVD is used for either skip or merge modes with a proposed motion vector expression method.

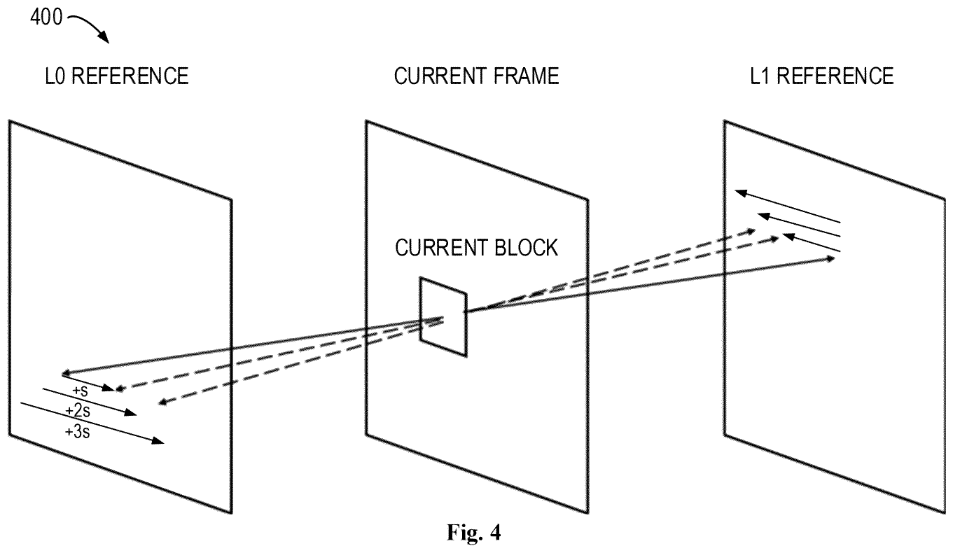

MMVD re-uses merge candidate as same as those included in the regular merge candidate list in VVC. Among the merge candidates, a base candidate can be selected, and is further expanded by the proposed motion vector expression method, as shown in FIG. 4.

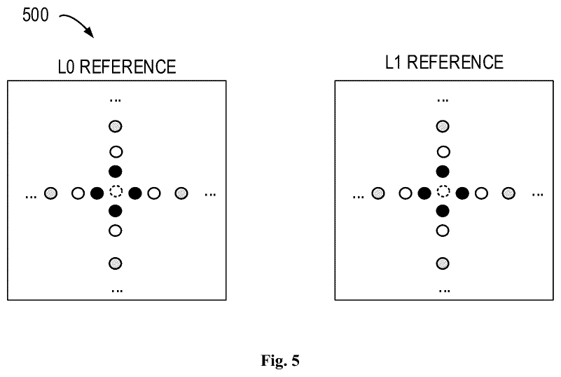

MMVD provides a new motion vector difference (MVD) representation method, in which a starting point, a motion magnitude and a motion direction are used to represent an MVD, as shown in FIG. 5. This MVD is referred to as a refinement or an offset. The size of this refinement in each x or y direction is referred to as a step size or distance offset, or simply a step.

This proposed technique uses a merge candidate list as it is. But only candidates which are default merge type (MRG_TYPE_DEFAULT_N) are considered for MMVD's expansion.

Base candidate index defines the starting point. Base candidate index indicates the best candidate among candidates in the list as follows.

TABLE 1
Base candidate IDX

| Base candidate IDX | 0 | 1 | 2 | 3 |
|---|---|---|---|---|
| N^{th} MVP | 1^{st} MVP | 2^{nd} MVP | 3^{rd} MVP | 4^{th} MVP |

If the number of base candidates is equal to 1, Base candidate IDX is not signaled.

Distance index is motion magnitude information. Distance index indicates the pre-defined distance from the starting point information. Pre-defined distance is as follows.

TABLE 2a
Distance IDX

| Distance IDX | 0 | 1 | 2 | 3 | 4 | 5 | 6 | 7 |
|---|---|---|---|---|---|---|---|---|
| Pixel distance | ¼-pel | ½-pel | 1-pel | 2-pel | 4-pel | 8-pel | 16-pel | 32-pel |

The distance IDX is binarized in bins with the truncated unary code in the entropy coding procedure as shown in the table below.

TABLE 2b
Distance IDX Binarization

| Distance IDX | 0 | 1 | 2 | 3 | 4 | 5 | 6 | 7 |
|---|---|---|---|---|---|---|---|---|
| Bins | 0 | 10 | 110 | 1110 | 11110 | 111110 | 1111110 | 1111111 |

In arithmetic coding, the first bin is coded with a probability context, and the following bins are coded with the equal-probability model, a.k.a. by-pass coding.

Direction index represents the direction of the MVD relative to the starting point. The direction index can represent of the four directions as shown below.

TABLE 3
Direction IDX

| Direction IDX | 00 | 01 | 10 | 11 |
|---|---|---|---|---|
| x-axis | + | − | N/A | N/A |
| y-axis | N/A | N/A | + | − |

It's noted that the meaning of MVD sign could be variant according to the information of starting MVs. When the starting MVs is an un-prediction MV or bi-prediction MVs with both lists point to the same side of the current picture (i.e. POCs of two references are both larger than the POC of the current picture, or are both smaller than the POC of the current picture), the sign specifies the sign of MV offset added to the starting MV. When the starting MVs is bi-prediction MVs with the two MVs point to the different sides of the current picture (i.e. the POC of one reference is larger than the POC of the current picture, and the POC of the other reference is smaller than the POC of the current picture), and the difference of POC in list 0 is greater than the one in list 1, the sign specifies the sign of MV offset added to the list0 MV component of starting MV and the sign for the list1 MV has opposite value. Otherwise, if the difference of POC in list 1 is greater than list 0, the sign specifies the sign of MV offset added to the list1 MV component of starting MV and the sign for the list0 MV has opposite value.

The MVD is scaled according to the difference of POCs in each direction. If the differences of POCs in both lists are the same, no scaling is needed. Otherwise, if the difference of POC in list 0 is larger than the one of list 1, the MVD for list 1 is scaled, by defining the POC difference of L0 as td and POC difference of L1 as tb. If the POC difference of L1 is greater than L0, the MVD for list 0 is scaled in the same way. If the starting MV is uni-predicted, the MVD is added to the available MV.

MMVD flag is singnaled right after sending a skip flag or merge flag. If skip or merge flag is true, MMVD flag is parsed. If MMVD flag is equal to 1, MMVD syntaxes are parsed. But, if not 1, AFFINE flag is parsed. If AFFINE flag is equal to 1, that is AFFINE mode, But, if not 1, skip/merge index is parsed for VTM's skip/merge mode. Additional line buffer due to MMVD candidates is not needed. Because a skip/merge candidate of software is directly used as a base candidate. Using input MMVD index, the supplement of MV is decided right before motion compensation. There is no need to hold long line buffer for this.

In current common test condition, either the first or the second merge candidate in the merge candidate list could be selected as the base candidate.

### 2.2 Affine Motion Compensation Prediction

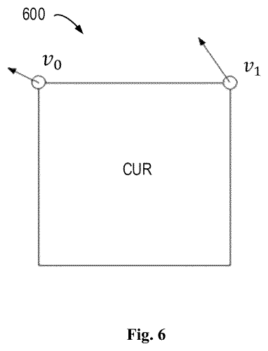

In HEVC, only translation motion model is applied for motion compensation prediction (MCP). While in the real world, there are many kinds of motion, e.g., zoom in/out, rotation, perspective motions and other irregular motions. In the JEM, a simplified affine transform motion compensation prediction is applied. As shown FIG. 6, the affine motion field of the block is described by two control point motion vectors.

The motion vector field (MVF) of a block is described by the following equation:

$$\{ \begin{matrix}{v}_{x} = \frac{( {v}_{1 x} - {v}_{0 x} )}{w} x - \frac{( {v}_{1 y} - {v}_{0 y} )}{w} y + {v}_{0 x} \\ {v}_{y} = \frac{( {v}_{1 y} - {v}_{0 y} )}{w} x + \frac{( {v}_{1 x} - {v}_{0 x} )}{w} y + {v}_{0 y}\end{matrix} \qquad ( 1 )$$

where (v₀ₓ, v_{0y}) is motion vector of the top-left corner control point, and (v₁ₓ, v_{1y}) is motion vector of the top-right corner control point.

In order to further simplify the motion compensation prediction, sub-block based affine transform prediction is applied. The sub-block size M×N is derived as in Equation 2, where MvPre is the motion vector fraction accuracy ( 1/16 in JEM), (v₂ₓ, v_{2y}) is motion vector of the bottom-left control point, calculated according to Equation 1.

$$\{ \begin{matrix}M = clip 3 ( 4 , w , \frac{w \times MvPre}{max ( abs ( {v}_{1 x} - {v}_{0 x} ) , abs ( {v}_{1 y} - {v}_{0 y} ) )} ) \\ N = clip 3 ( 4 , h , \frac{h \times MvPre}{max ( abs ( {v}_{2 x} - {v}_{0 x} ) , abs ( {v}_{2 y} - {v}_{0 y} ) )} )\end{matrix} \qquad ( 2 )$$

After derived by Equation 2, M and N should be adjusted downward if necessary to make it a divisor of w and h, respectively.

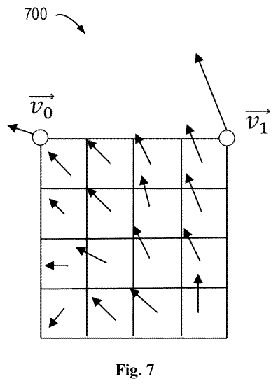

To derive motion vector of each M×N sub-block, the motion vector of the center sample of each sub-block, as shown in FIG. 7, is calculated according to Equation 1, and rounded to 1/16 fraction accuracy.

After MCP, the high accuracy motion vector of each sub-block is rounded and saved as the same accuracy as the normal motion vector.

2.3 Affine Merge Mode with Prediction Offsets

MMVD is extended to affine merge mode, this is referred to as an affine MMVD mode thereafter. The proposed method selects the first available affine merge candidate as a base predictor. Then it applies a motion vector offset to each control point's motion vector value from the base predictor. If there's no affine merge candidate available, this proposed method will not be used.

The selected base predictor's inter prediction direction, and the reference index of each direction is used without change.

In the current implementation, the current block's affine model is assumed to be a 4-parameter model, only 2 control points need to be derived. Thus, only the first 2 control points of the base predictor will be used as control point predictors.

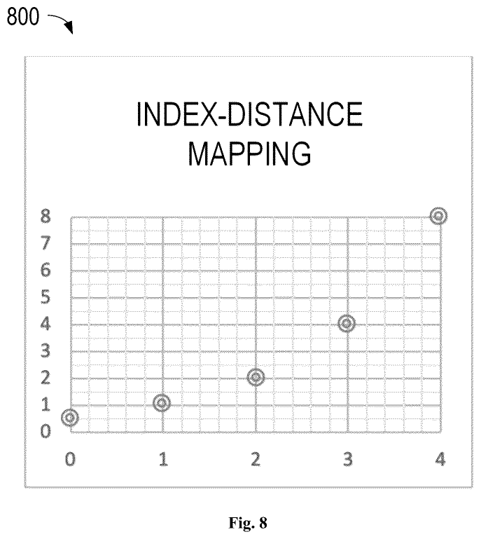

For each control point, a zero_MVD flag is used to indicate whether the control point of current block has the same MV value as the corresponding control point predictor. If zero_MVD flag is true, there's no other signaling needed for the control point. Otherwise, a distance index and an offset direction index is signaled for the control point. A distance offset table with size of 5 is used as shown in the table below. Distance index is signaled to indicate which distance offset to use. The mapping of distance index and distance offset values is shown in FIG. 8.

TABLE 4
Distance offset table

| Distance IDX | 0 | 1 | 2 | 3 | 4 |
|---|---|---|---|---|---|
| Distance-offset | ½-pel | 1-pel | 2-pel | 4-pel | 8-pel |

The direction index can represent four directions as shown in the table below, where only x or y direction may have an MV difference, but not in both directions.

TABLE 5
Direction index for four directions

| Offset Direction IDX | 00 | 01 | 10 | 11 |
|---|---|---|---|---|
| x-dir-factor | +1 | −1 | 0 | 0 |
| y-dir-factor | 0 | 0 | +1 | −1 |

If the inter prediction is uni-directional, the signaled distance offset is applied on the offset direction for each control point predictor. Results will be the MV value of each control point.

For example, when base predictor is uni-directional, and the motion vector values of a control point is MVP (vₚₓ, v_{py}). When distance offset and direction index are signaled, the motion vectors of current block's corresponding control points will be calculated as below:

$$MV ( {v}_{x} , {v}_{y} ) = MVP ( {v}_{px} , {v}_{py} ) + MV ( x - dir - factor * distance - offset , y - dir - factor * distance - offset ) .$$

If the inter prediction is bi-directional, the signaled distance offset is applied on the signaled offset direction for control point predictor's L0 motion vector; and the same distance offset with opposite direction is applied for control point predictor's L1 motion vector. Results will be the MV values of each control point, on each inter prediction direction.

For example, when base predictor is uni-directional, and the motion vector values of a control point on L0 is MVP_{L0} (v₀ₚₓ, v_{0py}), and the motion vector of that control point on L1 is MVP_{L1} (v₁ₚₓ, v_{1py}). When distance offset and direction index are signaled, the motion vectors of current block's corresponding control points will be calculated as below:

$${MV}_{L 0} ( {v}_{0 x} , {v}_{0 y} ) = {MVP}_{L 0} ( {v}_{0 px} , {v}_{0 py} ) + MV ( x - dir - factor * distance - offset , y - dir - factor * distance - offset ) ;$$

$${MV}_{L 1} ( {v}_{0 x} , {v}_{0 y} ) = {MVP}_{L 1} ( {v}_{0 px} , {v}_{0 py} ) + MV ( - x - dir - factor * distance - offset , y - dir - factor * distance - offset ) .$$

2.4 GPM with MMVD

A geometry partition mode (GPM) with MMVD (called GPM_MMVD) was proposed to further improve the coding efficiency of the GPM mode in the VVC. Specifically, in those schemes, additional MV differences (MVDs) are further applied on top of the existing GPM merge candidates to improve the precision of the MVs used by the two GPM partitions. Moreover, to reduce the signaling overhead, the MVDs are signaled in the same manner as the merge mode with MVD (MMVD) in the VVC.

Specifically, two flags are signaled to separately indicate whether additional MVD is applied to each GPM partition. When the flag of one GPM partition is true, its corresponding MVD is signaled in the same way as the MMVD, i.e., one distance index plus one direction index. To enable more MV combinations, the merge indices of two GPM partitions are allowed to be the same when the MVDs that are applied to the two partitions are not identical. Additionally, an MV pruning procedure is introduced to construct the GPM merge candidate list when GPM with MMVD is applied.

Additionally, two different sets of MVDs are supported for the GPM which are selected according to one indication flag at picture header. When the flag is equal to 0, the existing MVD set used by the MMVD, which includes 8 distances {¼-pel, ½-pel, 1-pel, 2-pel, 4-pel, 8-pel, 16-pel, 32-pel} and 4 horizontal/vertical directions, are supported for the GPM CUs in the current picture; otherwise, another MVD set, which include 9 distance {¼-pel, ½-pel, 1-pel, 2-pel, 3-pel, 4-pel, 6-pel, 8-pel, 16-pel} and 8 directions (4 horizontal/vertical directions plus 4 diagonal directions), are applied.

### 2.5 Local Illumination Compensation (LIC)

LIC is an inter prediction technique to model local illumination variation between current block and its prediction block as a function of that between current block template and reference block template. The parameters of the function can be denoted by a scale α and an offset β, which forms a linear equation, that is, α*p[x]+β to compensate illumination changes, where p[x] is a reference sample pointed to by MV at a location x on reference picture. Since α and β can be derived based on current block template and reference block template, no signaling overhead is required for them, except that an LIC flag is signaled for AMVP mode to indicate the use of LIC.

The local illumination compensation proposed in JVET-00066 is used for uni-prediction inter CUs with the following modifications.
Intra neighbor samples can be used in LIC parameter derivation.
LIC is disabled for blocks with less than 32 luma sample.
For both non-subblock and affine modes, LIC parameter derivation is performed based on the template block samples corresponding to the current CU, instead of partial template block samples corresponding to first top-left 16×16 unit.
Samples of the reference block template are generated by using MC with the block MV without rounding it to integer-pel precision.
   2.6 Bi-Prediction with CU-Level Weight (BCW)

In HEVC, the bi-prediction signal is generated by averaging two prediction signals obtained from two different reference pictures and/or using two different motion vectors. In VVC, the bi-prediction mode is extended beyond simple averaging to allow weighted averaging of the two prediction signals.

$${P}_{bi - pred} = ( ( 8 - w ) * {P}_{0} + w * {P}_{1} + 4 ) ≫ 3$$

Five weights are allowed in the weighted averaging bi-prediction, w∈{−2, 3, 4, 5, 10}. For each bi-predicted CU, the weight w is determined in one of two ways: 1) for a non-merge CU, the weight index is signalled after the motion vector difference; 2) for a merge CU, the weight index is inferred from neighbouring blocks based on the merge candidate index. BCW is only applied to CUs with 256 or more luma samples (i.e., CU width times CU height is greater than or equal to 256). For low-delay pictures, all 5 weights are used. For non-low-delay pictures, only 3 weights (w∈{3,4,5}) are used.
At the encoder, fast search algorithms are applied to find the weight index without significantly increasing the encoder complexity. These algorithms are summarized as follows. For further details readers are referred to the VTM software and document JVET-L0646. When combined with AMVR, unequal weights are only conditionally checked for 1-pel and 4-pel motion vector precisions if the current picture is a low-delay picture.
When combined with affine, affine ME will be performed for unequal weights if and only if the affine mode is selected as the current best mode.
When the two reference pictures in bi-prediction are the same, unequal weights are only conditionally checked.
Unequal weights are not searched when certain conditions are met, depending on the POC distance between current picture and its reference pictures, the coding QP, and the temporal level.

The BCW weight index is coded using one context coded bin followed by bypass coded bins. The first context coded bin indicates if equal weight is used; and if unequal weight is used, additional bins are signalled using bypass coding to indicate which unequal weight is used.

Weighted prediction (WP) is a coding tool supported by the H.264/AVC and HEVC standards to efficiently code video content with fading. Support for WP was also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g., equal weight.

### 3. PROBLEMS

There are several problems in the current MMVD design.
The number of the directions are limited. It is only limited to 4 directions and does not cover other directions.
The distance set is fixed and does not depend on the block size, or motion vector magnitude, or direction.
Coding direction and distance separately could be suboptimal if there is any strong correlation between them.
It does not use the neighboring block template information for deciding the refinement value (e.g. which direction(s) and/or distance(s) and/or base candidate(s) will be finally checked).

### 4. DETAILED SOLUTIONS

The detailed solutions below should be considered as examples to explain general concepts. These solutions should not be interpreted in a narrow way. Furthermore, these solutions can be combined in any manner.

The methods disclosed below may be applied to MMVD, and extensions of MMVD (e.g., the affine MMVD or GPM MMVD (GMVD), MMVD for IBC mode, MMVD for affine IBC mode). In the following descriptions, the terminology ‘MMVD’ may be utilized to represent a coding tool wherein partial of motion information (e.g., reference picture index, prediction direction from List 0/1, and base motion vectors) is inherited from a candidate while indication of some additional refinement of refined motion information (e.g., refined my differences) is further signaled in the bitstream.

### On Extension of Directions Used in MMVD Design.

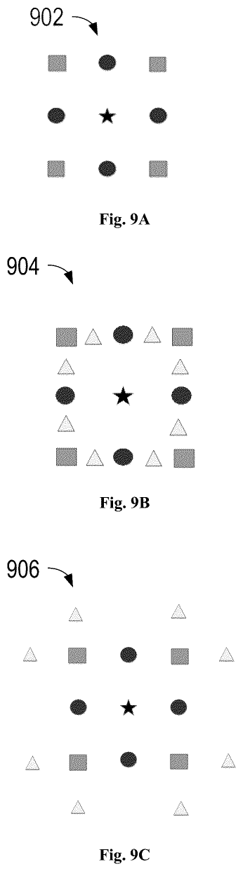

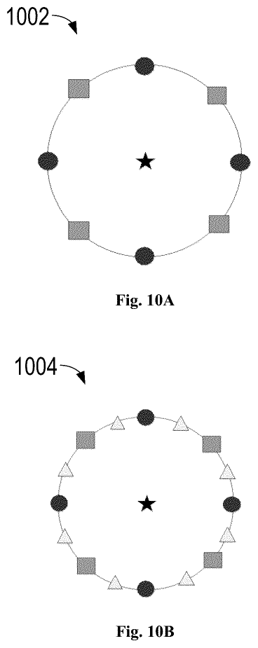

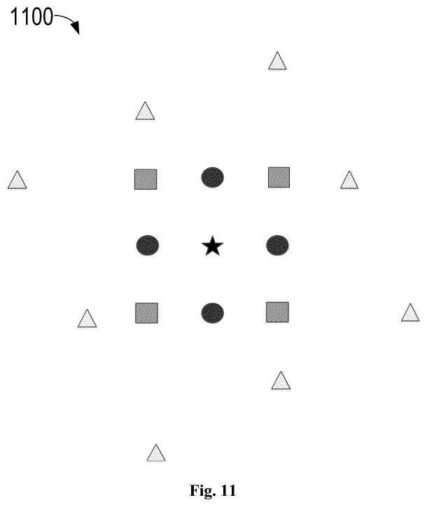

1. Slash/asymmetric directions or diagonal directions may be utilized for MMVD coded blocks.
   a. The diagonal direction may be defined as M*pi/N wherein M and N are both non-zero integers, M<N.
      i. In one example as depicted in FIG. 9A with square dot, at least one of the four diagonal direction positions could be added to the original four horizontal and vertical directions. FIGS. 9A-9C illustrates some example implementations of adding diagonal angles, in FIG. 9A square dots represent new pi/4 diagonal angels, in FIG. 9B square and triangle dots represent the new pi/8 angels with roughly similar size, in FIG. 9C square and triangle dots represent the new pi/8 angels with different size.
      ii. In one example as depicted in FIG. 9B with square dots and triangle dots, at least one of the additional 8 directions could be added to the previous 8 directions at angles k*pi/8.
      iii. In one example as depicted in FIG. 9C with square dots and triangle dots, at least one of the additional 8 directions could be added to the previous 8 directions at angles k*pi/8, with asymmetric distance offset.
      iv. In one example, at least one of the additional 16 directions could be added to the previous 16 directions at angles k*pi/16.
      v. In one example as depicted in FIGS. 10A and 10B with square dots and triangle dots, at least one of the additional 4 or 8 directions could be added to the previous 4 or 8 directions at angles k*pi/8, with exact similar distance offset around a circle. FIGS. 10A and 10B illustrate some example implementations of adding diagonal angles with exact similar distance around a circle, in FIG. 10A square dots represent new pi/4 diagonal angels, in FIG. 10B square and triangle dots represent the new pi/8 angels.
   b. Asymmetric angles and/or with asymmetric distances may be utilized in the MMVD design.
      i. One example is as depicted in FIG. 11, wherein square dots and triangle dots present the additional directions.
   c. The directions mentioned above may be added as additional directions in addition to those in the prior art.
      i. Alternatively, it may be used to replace at least one of the existing directions defined in the prior art.
   d. In one example, the additional asymmetric/slash offset or additional diagonal directions for MMVD and/or its extensions (e.g., affine MMVD) may be indicated by an index to be coded jointly or separately for the directional and distance offsets.
      i. In one example, the index may be coded with truncated binary/binary code.
      ii. In one example, the index may be all coded using truncated unary code.
      iii. In one example, the index may be all coded using Rice or exponential Golomb code of order k which k could be 0, 1, or any number.
         (i) In one example, the rice code with parameter 1, 2, 4, 8 or any other number may be used.
      iv. In one example, the prefix and suffix of the codes may be coded in any combination of bypass and context coded bin.
      v. In one example, the index could be coded in bypass mode.
      vi. In one example, the index could be coded in context mode.
      vii. In one example, at least one bin of the index (such as only the first bin) may be context coded.
      viii. In one example, the first N bins may be context coded. The context coded may share the same context or have independent context.
2. Whether to and/or how many directions should be utilized may be signaled or derived on-the-fly (e.g., according to decoded information).
   a. In one example additional directions could be added only for some particular block sizes.
      i. In one example additional direction may be added to blocks with width*height>C1.
         (i) An example for C1 could be 64 or 256.
      ii. In one example additional direction may be added to blocks with width*height<C1.
         (i) An example for C1 could be 64 or 256.
      iii. In one example additional direction may be added to blocks with width>C1 and/or height>C2.
         (i) An example for C1 and C2 could be 16 and 32 respectively.
      iv. In one example additional direction may be added to blocks with width<C1 and/or height<C2.
         (i) An example for C1 and C2 could be 16 and 32 respectively.
      v. The thresholds C1/C2 mentioned above may be pre-defined or signaled in the bitstream.
   b. In one example, whether to apply additional directions and/or which additional directions to be used may be based on the picture resolution and/or reference picture list and/or low-delay check flag.
   c. In one example, whether to apply additional directions and/or which additional directions to be used, may be signaled from an encoder to a decoder such as in SPS/PPS/VPS/APS/slice header/picture header/CTU/CU/PU, etc.
      i. For example, pictures at low temporal layers may use more directions, and/or pictures at high temporal layers may use fewer directions.

### On Extension of Distance Offsets Used in MMVD Design.

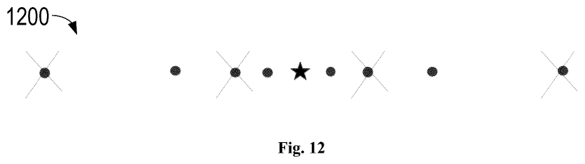

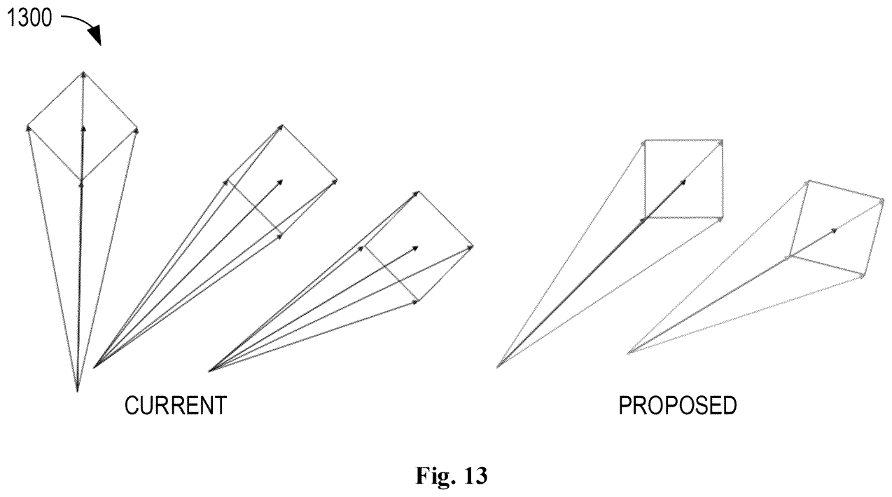

3. It is proposed that at least one extra distance could be added to or at least one existing distance could be removed from the original distance set (or candidate list) for MMVD mode and/or extensions of MMVD mode.
   a. It is proposed that at least one extra distance offset could be added to the original 8 distance offsets for MMVD and/or GMVD and 5 original distance offsets for Affine MMVD refinement candidates.
   b. Alternatively, at least one distance offset may be removed from the original 8 distance offsets for MMVD and 5 original distance offsets for Affine MMVD refinement candidates.
   c. In one example, at least one additional distance offset could be added between and/or beyond the original 8 MMVD distance offsets. The number of additional distance offsets could be 4 or 8 or any other number.
   d. In one example, at least one additional distance offset could be added between and/or beyond the original 5 Affine MMVD distance offsets. The number of additional distance offsets could be 4, 5, or 8 or any other number.
   e. In one example, at least one additional distance offset could be added only between two distance offsets, which are both smaller than a threshold.
   f. In one example, at least one additional distance offset could be added only between two distance offsets, which are both larger than a threshold.
   g. In one example some distance offsets could be removed, and the number of the distance offsets could be reduced to N (e.g. 3, or 4, or 5).
   h. In one example, every other distance offset could be removed starting removal from the 2^{nd} distance offset as depicted in FIG. 12.
   i. In one example, every other distance offset could be removed starting removal from the first distance offset.
   j. In one example, the first half distance offsets (e.g., idx 0, 1, 2, 3 for MMVD) could be removed.
   k. In one example, the second half (e.g., idx 4, 5, 6, 7 for MMVD) could be removed.
   l. In one example the final offsets which may be indicated as a joint index for all offsets or divided to 2 indexes for directional and distance offset, may be coded with Truncated unary code, or truncated binary code, or Rice code of parameter R or Exponential Golomb code of order k, with any combination of bypass and context coded bin.
4. The initial distance offset candidate list may be pre-defined or signaled or derived on-the-fly.
   a. In one example, depending on the block size, initial distance offset candidate list may be chosen.
      i. As an example, one set of distance offsets is chosen for blocks with width*height>C, and a different set is chosen for the remaining.
5. It is proposed that whether to apply additional direction(s) and/or additional offset(s), and/or which additional direction(s) and/or additional offset(s) should be applied, could be dependent on the original base motion vector direction and/or its magnitude, for MMVD and/or extensions of MMVD (e.g. Affine MMVD and/or GMVD).
   a. In one example, the initial offset could be determined by the base MV magnitude.
      i. MV magnitude may be derived by MVx and MVy. E.g., MV magnitude is calculated as |MVx|+|MVy|.
      ii. MV magnitude may be derived by MVx and MVy. E.g., MV magnitude is calculated as (MVx)\hat{ }2+(MVy)\hat{ }2.
      iii. If both the Ref0 and Ref1 are available, the magnitude may be a weighted average of the MV length of each of the Ref list MV.
      iv. For Affine MMVD, the top-left control point MV magnitude of the base affine MVs could be used to determine the initial offset with those methods specified in i, ii, iii.
   b. In one example, the initial distance offset for MV magnitude>C1 could be larger than the initial distance offset for MV magnitude<C1.
      i. In one example, the initial distance offset for MV magnitude>C1 could be N times of the initial distance offset for MV magnitude<C1, where C1 for example could be 50 pixels, and N for example could be 2.
   c. In one example, at least one directional offset could be derived from the base MV. For Affine MMVD, the top-left control point MV of the base affine MVs could be used to derive the additional directional offset.
      i. In one example, this directional offset could be precise, such as being parallel or perpendicular to that of the original base MV as depicted in FIG. 13.
      ii. In one example, an additional directional offset could be approximated, such as if the base MV direction is between pi/8 and 3pi/8, diagonal directional offset could be used, otherwise vertical/horizontal directional offset would be used.
      iii. directional offsets may replace the offsets in the original design of MMVD/GMVD/affine MMVD.
         I. Alternatively, directional offsets may be added to be used together with the original design of MMVD/GMVD/affine MMVD.

### MMVD Reordering

6. It is proposed the base motion candidates and/or motion candidates after refinement (e.g., by adding the MVD) for MMVD mode and/or extensions of MMVD (e.g., the affine MMVD or GPM MMVD (GMVD), MMVD for IBC mode, MMVD for affine IBC mode) mode may be reordered.
   a. In one example, the reordering process should be performed before the MMVD refinement method being interpreted from at least one syntax elements.
   b. In one example, the N1 refinement steps as well as N2 directions as well as N3 base candidates which construct N1*N2*N3 possibilities may be reordered together.
      i. N1 may be 4, 5, 8, 16 or any other number. N2 may be 2, 4, 6, 8, 16, 32 or any other numbers. N3 maybe 1, 2, 3, 4, or any other numbers.
   c. In one example, N possible refinement positions (could be asymmetric for direction, or step, or no clear direction or steps) as well as N3 base candidates which construct N*N3 possibilities may be reordered together.
   d. In one example, the reordering process could be done for each base candidate separately.
      i. For example, the N1 refinement steps as well as N2 directions which construct N1*N2 possibilities may be reordered together, for each base candidate.
      ii. For example, if there are total of N possible refinement positions (could be asymmetric for direction, or step, or no clear direction or steps) may be reordered together, for each base candidate.
      iii. In one example, the base candidates may be reordered in advance. Afterwards, the refinement of the first base candidate is further applied.
         (i) For example, the N1 refinement steps as well as N2 directions which construct N1*N2 possibilities may be reordered together, for the first base candidate.
         (ii) For example, if there are total of N possible refinement positions (could be asymmetric for direction, or step, or no clear direction or steps) may be reordered together, for the first base candidate.
   e. In one example, the reordering process could be done for candidates with a same base candidate and a same direction separately. For example, the N1 refinement steps may be reordered together, for candidates with a same base candidate and a same direction independently.
   f. In one example, the reordering process could be done for candidates with a specified base candidate and a specified direction separately. For example, the N1 refinement steps may be reordered together, for candidates with a specified base candidate and a specified direction independently.
   g. In one example, the reordering process could be done for candidates with a same base candidate and a same refinement step separately. For example, the N2 directions may be reordered together, for candidates with a same base candidate and a same refinement step independently.
   h. In one example, the reordering process could be done for candidates with a specified base candidate and a specified refinement step separately. For example, the N2 directions may be reordered together, for candidates with a specified base candidate and a specified refinement step independently.
   i. In one example any subgroup of the possible options could be reordered just inside of that subgroup.
      i. In one example, the subgroup is divided from all the candidates for MMVD according to the direction.
      ii. In one example, the subgroup is divided from all the candidates for MMVD according to the distance.
      iii. In one example, the subgroup is divided from all the candidates for MMVD according to the base candidate.
      iv. In one example, the subgroup is divided from all the candidates for MMVD according to any combinations of direction, distance, and the base candidate.
   j. In one example reordering process may be applied sequentially based on the characteristics.
      i. As an example, first reordering process for base candidates may be performed. Next reordering process for directions may be performed with a fixed distance offset. Finally reordering process for the distance offsets may be performed.
      ii. Alternatively, first reordering process for base candidates may be performed. Next reordering process for each direction and distance combination with a same base candidate may be performed.
      iii. Alternatively, first reordering process for base candidates may be performed. Next reordering process for each direction and distance combination with a specified (e.g., the first) base candidate may be performed.
   k. In one example, the reordered MMVD and/or its extensions (e.g., affine MMVD) may be indicated by an index to be signaled,
      i. In one example, the index may be all coded using truncated unary code.
      ii. In one example, the index may be all coded using truncated binary/binary code.
      iii. In one example, the index may be all coded using Rice or exponential Golomb code of order k which k could be 0, 1, or any number.
         (i) In one example, the rice code with parameter 1, 2, 4, 8 or any other number may be used.
      iv. In one example, the prefix and suffix of the codes may be coded in any combination of bypass and context coded bin.
      v. In one example, the index could be coded in bypass mode.
      vi. In one example, the index could be coded in context mode.
      vii. In one example, at least one bin of the index (such as only the first bin) may be context coded.
         (i) In one example, the first N bins may be context coded. The context coded may share the same context or have independent context.
   l. In one example, base candidate indexes may be coded separately such as in truncated unary or truncated binary in context or bypass coded bins. The remaining directions and distances may be coded as described above.
   m. In one example, after reordering the MMVD candidates, only the top N numbers with the lowest costs are kept. N could be any integers. Only the new limited options will be coded.
      i. In one example after reordering the MMVD candidates, only the top half with the lowest costs are kept. Only the new limited options will be coded.
      ii. In one example after reordering the MMVD candidates, only the top ¼^{th} with the lowest costs are kept. Only the new limited options will be coded.
      iii. In one example after reordering the MMVD candidates, only the top ⅛^{th} with the lowest costs are kept. Only the new limited options will be coded.
      iv. In one example after reordering the MMVD candidates, only the top 1/16^{th} with the lowest costs are kept. Only the new limited options will be coded.
   n. In one example, only candidates with cost smaller than F*bestCost may be selected. F maybe any number such as 1.2, 2, 2.5, . . . and bestCost is the best (e.g., smallest) template matching cost of the candidates.
   o. In one example, any combination of selecting candidates based on a fixed ratio from best template matching cost, or choosing top N, or limiting based on the block size and/or base MV magnitude and/or base MVdirection may be used.
   p. In one example, the reordering process may be limited to a special block size. As an example, reordering may be applied for blocks with width*height>C, and reordering may not be applied for the remaining.
   q. In one example, after reordering process, only the best MMVD candidate may be selected, and no additional index signaling may be necessary.
7. The reordering may be based on a template matching approach.
   a. In one example, the reorder criteria for the candidates may be template matching cost between a template around the current block and the reference for that template.
      i. In one example this cost may be Sum of Absolute Difference (SAD) between the template samples and their references.
      ii. In one example this cost may be Sum of Absolute Transformed Difference (SATD) or any other cost measure between the template samples and their references.
      iii. In one example this cost may be Mean Removal based Sum of Absolute Difference (MR-SAD) between the template samples and their references.
      iv. In one example this cost may be a weighted average of SAD/MR-SAD and SATD between the template samples and their references.
      v. In one example, the cost function between current template and reference template may be:
         (i) Sum of absolute differences (SAD)/mean-removal SAD (MR-SAD);
         (ii) Sum of absolute transformed differences (SATD)/mean-removal SATD (MR-SATD);
         (iii) Sum of squared differences (SSD)/mean-removal SSD (MR-SSD);
         (iv) SSE/MR-SSE;
         (v) Weighted SAD/weighted MR-SAD;
         (vi) Weighted SATD/weighted MR-SATD;
         (vii) Weighted SSD/weighted MR-SSD;
         (viii) Weighted SSE/weighted MR-SSE;
         (ix) Gradient information.
   b. The cost may consider the continuity (Boundary_SAD) between reference template and reconstructed samples adjacently or non-adjacently neighboring to current template in addition to the SAD calculated in (f). For example, reconstructed samples left and/or above adjacently or non-adjacently neighboring to current template are considered.
      i. In one example, the cost may be calculated based on SAD and Boundary_SAD.
         (i) In one example, the cost may be calculated as (SAD+w*Boundary_SAD). w may be pre-defined or signaled or derived according to decoded information.
   c. In one example K1 rows on the top and/or K2 columns on the left and/or K1*K2 samples/pixels on the corner may be used as the template.
      i. K1 and K2 could be any number; as an example, K1 and K2 could be 1, 2, 3, width/2, height/2, width, height.
      ii. Alternatively, only K1 rows on the top are used as the template.
      iii. Alternatively, only K2 columns on the left are used as the template.
      iv. Alternatively, K1 rows on the top and K2 columns on the left are used as the template.
   d. The template matching procedure may comprise one component such as luma.
      i. Alternatively, the template matching procedure may comprise multiple components such as luma and chroma.
         (i) In one example, the total template matching cost may be calculated as a weighted sum of template matching costs on different color components.
   e. In one example, the reference samples of the template (RT_{bi-pred}) for bi-directional prediction are derived by weighted averaging of the reference samples of the template in reference list0 (RT₀) and the reference samples of the template in reference list1 (RT₁). One example is as follows:

RT=((2^{N}−w)*RT₀+w*RT₁+2^{N-1})>>N, for example, N=3.
f. In one example, the weight of the reference template in reference list0 such as (8−w) and the weight of the reference template in reference list1 such as (w) maybe decided by the BCW index of the merge candidate.
   i. In one example, BCW index is equal to 0, w is set equal to −2.
   ii. In one example, BCW index is equal to 1, w is set equal to 3.
   iii. In one example, BCW index is equal to 2, w is set equal to 4.
   iv. In one example, BCW index is equal to 3, w is set equal to 5.
   v. In one example, BCW index is equal to 4, w is set equal to 10.
g. In one example, if the Local Illumination Compensation (LIC) flag of the merge candidate is true, the reference samples of the template are derived with LIC method.
   i. Alternatively, the reference samples of the template are derived without LIC.
h. In one example, when deriving the reference samples of the template, the motion vectors of the merge candidate are rounded to the integer pixel accuracy, where the integer motion vector may be its nearest integer motion vector.
i. In one example, when deriving the reference samples of the template, N-tap interpolation filtering is used to get the reference samples of the template at sub-pixel positions. For example, N may be 2, 4, 6, 8, or 12.
8. Early termination of reordering process may be applied.
   a. In one example, only candidates associated with a certain direction may be further checked under certain conditions are satisfied.
   b. In one example, only candidates associated with a certain distance offset, but different directions may be further checked under certain conditions are satisfied.

### On MVD Sign Prediction

9. It is proposed a sign of MVD, for Advanced Motion Vector Prediction (AMVP) mode and/or its extensions (e.g., affine AMVP), MMVD mode and/or extensions of MMVD (e.g., the affine MMVD or GPM MMVD (GMVD), MMVD for IBC mode, MMVD for affine IBC mode) mode may be predicted (or reordered).
   a. In one example the sign of MVD horizonal component (MVx) may be predicted.
   b. In one example the sign of MVx may be predicted (reordered), and one flag is coded to determine whether the prediction is correct or not.
   c. In one example the sign of MVD vertical component (MVy) may be predicted.
   d. In one example the sign of MVy may be predicted (reordered), and one flag is coded to determine whether the prediction is correct or not.
   e. In one example the signs of the MVx and MVy may be predicted jointly. More precisely, there are 4 possible combinations for the MVx and MVy signs: (+,+), (+,−), (−,+), (−,−). After prediction no extra information may be coded.
   f. In one example, the possible combinations may depend on whether MVx and/or MVy is equal to zero.
   g. In one example the signs of the MVx and MVy may be predicted (reorders), and one flag is coded to determine if the first option chosen or the second. This flag may be context coded or bypass coded.
   h. In one example the signs of the MVx and MVy may be predicted (reordered), and the top N (e.g. N=2, 3, . . . ) options may be signaled with an index which is coded with a non-fixed length code (e.g. Unary or Truncated Unary code, or Binary code). The index may be context coded or bypass coded.
      i. In one example, if a first option is before a second option after reordering, the code length of the first option should be no longer than that of the second option.
   i. In one example, the sign of MVx and/or MVy may be coded with a context coding, wherein the context may be determined by a prediction of MVx and/or MVy.
   j. In one example, the sign of MVx and/or MVy may be coded with a context coding, wherein the context may be dependent on the magnitude of the MVD component.
   k. In one example, the information indicating whether a prediction is correct or not for a MVx and/or a MVy may be signaled conditionally.
      i. In one example, the information may not be signaled if the MVx and/or the MVy is equal to zero.
   l. In one example, the sign of MVx and/or MVy may not be signaled explicitly, but set equal to the prediction value implicitly.
10. The sign prediction (or reordering) of MVD may be based on a template matching approach or bilateral matching approach.
   a. In one example, the reorder criteria for the candidates may be template matching cost between a template around the current block and the reference for that template.
      i. In one example this cost may be Sum of Absolute Difference (SAD) between the template samples and their references.
      ii. In one example this cost may be Sum of Absolute Transformed Difference (SATD) or any other cost measure between the template samples and their references.
      iii. In one example this cost may be Mean Removal based Sum of Absolute Difference (MR-SAD) between the template samples and their references.
      iv. In one example this cost may be a weighted average of SAD/MR-SAD and SATD between the template samples and their references.
      v. In one example, the cost function between current template and reference template may be:
         (i) Sum of absolute differences (SAD)/mean-removal SAD (MR-SAD);
         (ii) Sum of absolute transformed differences (SATD)/mean-removal SATD (MR-SATD);
         (iii) Sum of squared differences (SSD)/mean-removal SSD (MR-SSD);
         (iv) SSE/MR-SSE;
         (v) Weighted SAD/weighted MR-SAD;
         (vi) Weighted SATD/weighted MR-SATD;
         (vii) Weighted SSD/weighted MR-SSD;
         (viii) Weighted SSE/weighted MR-SSE;
         (ix) Gradient information.
   b. In one example, build MV candidates by creating combination between possible signs and absolute MVD value and add it to the MV predictor. Derive MVD sign prediction cost for each derived MV candidate based on template matching cost or bilateral matching cost and sort the MVD signs ascendingly according to cost values.
      i. In one example, the true MVD sign used finally may be the MVD sign with the smallest MVD sign prediction cost.
      ii. In one example, the true MVD sign used finally may be selected among the first N (e.g. N=2, 3, . . . ) MVD signs in the sorted MVD sign list.
         (i) In one example, the selected MVD sign (i.e. the true MVD sign used finally) may be signaled with a flag or an index. And the flag or index may be context coded or bypass coded.

### On Combination of MVD Sign Prediction and MMVD Reordering

11. It is proposed that any of MVD sign prediction for AMVP mode and/or its extensions (e.g., affine AMVP), MMVD mode and/or its extensions may be combined with any MMVD reordering for MMVD mode and/or extensions of MMVD (e.g., the affine MMVD or GPM MMVD (GMVD), MMVD for IBC mode, MMVD for affine IBC mode).
   a. In one example any MVD sign prediction for AMVP may be combined with any MMVD reordering for MMVD.
   b. In one example any MVD sign prediction for affine AMVP may be combined with any MMVD reordering for affine MMVD.
   c. In one example any MVD sign prediction for AMVP and affine AMVP may be combined with any MMVD reordering for MMVD and affine MMVD.
   d. In one example any MVD sign prediction for AMVP and affine AMVP and affine MMVD, may be combined with any MMVD reordering for MMVD.
   e. In one example any MVD sign prediction for AMVP and affine AMVP and MMVD, may be combined with any MMVD reordering for affine MMVD or its other extensions.
   f. In one example both sign prediction and MMVD reordering, may be applied on MV simultaneously. For example, sign prediction would be applied on MMVD sign, and MMVD reordering may be applied on MMVD magnitude or its base.
   g. In one example, sign prediction may be applied to MVD coding methods excluding MMVD (such as AMVP), but MMVD reordering may be applied to MMVD mode.
      On MMVD (and/or Affine MMVD) for Bi-Prediction Base Candidate

Denote the MVD candidate list of list X (e.g., X=0) as {MvdLXᵢ} wherein i is in the range of [0, M−1] and M is the total number of allowed MVD candidates for list X. The MVD candidate list of list Y (e.g., Y=1−x) as {MvdLYⱼ} wherein j is in the range of [0, N−1] and N is the total number of allowed MVD candidates for list Y.
12. Instead of always signaling the MVD information for list 0, it is proposed to signal the MVD information for list 1.
   a. Alternatively, whether to signal it for list 0 or list 1 may be further indicated in the bitstream or determined on-the-fly (e.g., according to the reference picture information of the base candidate).
13. It is proposed that N and M may be unequal.
   a. In one example, N and/or M may be pre-defined or determined on-the-fly or signalled.
14. It is proposed that the MMVD for bi-prediction may be modified to:
   a. In one example List 0 and list 1 having their own independent MVD wherein the MvdLYᵢ is not derived from the MvdLXᵢ using the prior art.
   b. In one example only List 0 has MVD and List 1 has no MVD (0).
   c. In one example only List 1 has MVD and List 0 has no MVD(0).
   d. In one example only the reference picture with closest distance to current picture may have MMVD, and the other one has no MVD (0).
   e. In one example only the reference picture with further distance to current picture may have MMVD, and the other one has no MVD (0).
   f. In one example, only the reference direction (List 0 or List 1) whose MV has larger cost may have MVD.
      i. In one example, only the reference direction (List 0 or List 1) whose MV has the smaller cost may have MVD.
      ii. In one example, the cost may be the template matching cost corresponding to the MV of one reference list (List 0 or List 1).
      iii. In one example, the cost may be the bilateral matching cost corresponding to the MV of one reference list (List 0 or List 1).
   g. In one example only the reference ahead of the current picture may have MVD.
   h. In one example only the reference after the current picture may have MVD.
   i. In one example depending on the reference block's MV size or angle, only one may have MVD.
   j. In one example bi-prediction candidates may be converted to a uni candidate and MVD may apply on it.
   k. In one example, among both List 0 and List 1 have MVD, only List 0 has MVD, only List 1 has MVD, which one is finally used may be determined by RD decision and signaled to the decoder.
15. It is proposed to the final MVDs of list 0 and list 1 may be (MvdLXᵢ, MvdLYⱼ) pairs wherein i is unequal to j.
   a. In one example, for all (MvdLXᵢ, MvdLYⱼ) pairs with i being equal or unequal to j, the template costs may be calculated. and the pair which gives the smallest template cost may be selected as the final MVDs for list 0 and list 1.
      i. Alternatively, furthermore, early termination may be applied to reduce number of pairs to be checked.
16. It is proposed to determine the final MVD of list 0 and list 1 separately.
   a. In one example, instead of calculating the template cost based on the (MvdLXⱼ, MvdLYⱼ) pair, the template cost may be calculated for each candidate in list 0 and list 1 independently.
      ii. Alternatively, furthermore, the MvdLXⱼ with the smallest template cost may be used as the final MVD for list X.
17. It is proposed to add zero MVD to the MVD candidate list in MMVD design.
18. It is proposed to have one sided bi-prediction MMVD (and/or affine MMVD) only added to list 0, one sided bi-prediction MMVD only added to list 1, and two sided bi-prediction added to both list, all at the same time.
   a. In one example similar number of the candidate for each of these 3 categories may be use. This number could be any integer such as 8, 16, . . .
   b. In another example each category could have their own number of the candidates, which may differ from the other categories.

### On Template Reference Samples

19. It is proposed that a first interpolation filter used to generate the template reference samples for MMVD reordering and/or MVD sign prediction may be different from a second interpolation filter used to generate the reference samples for inter-prediction.
   a. For example, the first interpolation filter may have less taps that the second interpolation filter.
   b. For example, the first interpolation filter may be a bi-linear filter or a 4-tap filter.
   c. In one example 12-tap interpolation filter may be used.
20. It is proposed that a first interpolation filter used to generate the template reference samples for MMVD reordering and/or MVD sign prediction may be different from a second interpolation filter used to generate the r template reference samples for another coding tool, e.g., TM-based merge candidate list.
21. It is proposed a modified MV (e.g., an estimation for MV magnitude) may be used for MVD sign prediction or MMVD reordering.
   a. In one example nearest integer estimation may be used for prediction/reordering.
   b. In one example nearest half pxl estimation may be used for prediction/reordering.
   c. In one example nearest 4-pxl estimation may be used for prediction/reordering.

### On Extension of Number of the Base Candidates Used in MMVD

22. It is proposed that at least one extra base candidate could be added to the original base candidates for MMVD and/or its extensions (e.g., affine MMVD).
   a. Alternatively, at least one existing base candidate could be removed from the original base candidates for MMVD and/or its extensions (e.g., affine MMVD).
   b. In one example depending on the block size, additional base candidates may be added.
   c. In one example depending on the picture resolution, additional base candidates may be added.
   d. In one example depending on the similarity/difference between the original base candidates, additional ones may be added.
   e. Alternatively, depending on the block size and/or the temporal level and/or the picture resolution and/or the similarity/difference between the original base candidates, at least one existing base candidate may be removed from the original base candidates.
   f. The base candidate index may be coded with truncated unary code, or truncated binary code, or Rice code of parameter R or Exponential Golomb code of order k, with any combination of bypass and context coded bin.
      i. Alternatively, it may be combined with the offset index and be coded jointly.

### On Early Termination of Cost Calculation

23. It is proposed that there may be an early termination on cost calculation for a first candidate or candidate position.
   a. In one example, if the cost of the left template samples is higher than the maximum allowable cost, the cost calculation for the above template samples may be skipped.
   b. In one example, if the cost of the above template samples is higher than the maximum allowable cost, the cost calculation for the left template samples may be skipped.
   c. In one example, depending on the width and height of the block, the longer template side cost may be calculated first, and if the cost is higher than the maximum allowable cost, the cost calculation for the shorter template side may be skipped.
   d. In one example, the maximum allowable cost mentioned above may be a fixed number.
   e. In another example, the maximum allowable cost mentioned above may be variable and may be a function of the block size, width, height, a fixed threshold, last cost, best cost, etc.
   f. In one example, if selecting N candidates (such as with the lowest costs) from M candidates, the maximum allowable cost mentioned above may be the Nth lowest cost.
   g. In another example the maximum allowable cost mentioned above may be the cost of a second candidate or candidate position.
      i. In one example, the second candidate or candidate position may be with the k-th lowest cost when calculating the cost of the first candidate or candidate position.

### On Affine MMVD

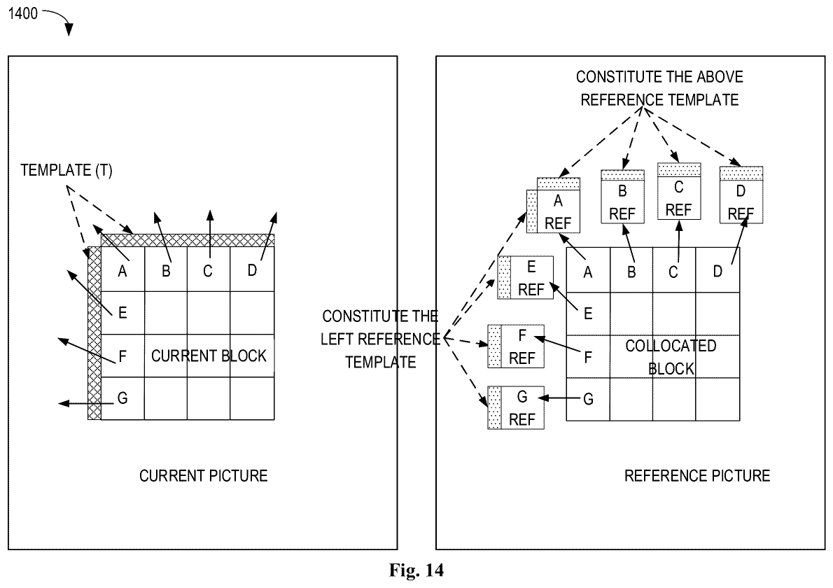

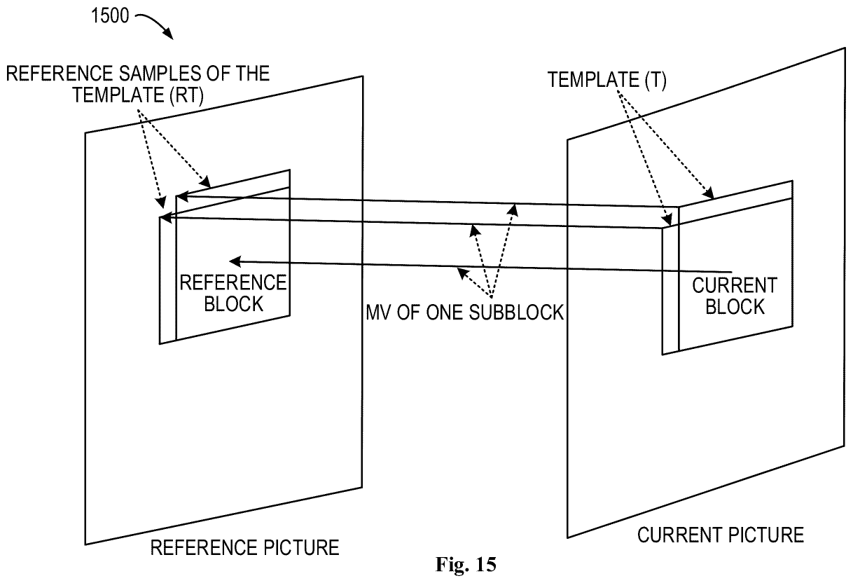

24. It is proposed that there may be some simplification on affine MMVD reference template derivation. For subblock-based merge candidates with subblock size equal to Wsub*Hsub, the above template comprises several sub-templates with the size of Wsub×L, and the left template comprises several sub-templates with the size of L×Hsub. As shown in FIG. 14. the motion information of the subblocks in the first row and the first column of current block is used to derive the reference samples of each sub-template.
   a. In one example the prediction may be calculated for each 4×4 subblocks.
   b. In one example the prediction may be calculated for each 8×8 subblocks.
   c. In one example the prediction may be calculated for each min(4, width)×min(4, height) subblocks.
   d. In one example the prediction may be calculated for each (width/2)×(height/2) subblocks.
   e. In one example the prediction may be calculated for each (width)×(height) subblocks (as shown in FIG. 15).
   f. In one example there may be no LIC application for affine MMVD.
   g. In one example there may be no LIC application when calculating the cost for affine MMVD.
25. It is proposed that whether to check the affine MMVD options or not at encoder side may depends on the affine merge cost.
   a. In one example if the best affine merge cost is on the top N merge or non merge costs, the affine MMVD options may be checked in encoder. Otherwise, they may be skipped. N could be any number such as 1, 3, 5, 10, 20, . . .
   b. In one example if the best affine cost is not on top N costs, the affine MMVD options may be checked in encoder. Otherwise, they may be skipped. N could be any number such as 1, 3, 5, 10, 20, . . .
   c. In another example if the best affine cost is smaller than the alpha*cost_t, the affine MMVD options may be checked in encoder. Otherwise, they may be skipped. Alpha could be any positive real number such as 0.7, 1, 1.25, 1.73, . . . , and cost_t may be the best non affine cost, or the N'th best cost, where N may be any integer number such as 5, 10.
   d. In another example if the best affine cost is bigger than the alpha*cost_t, the affine MMVD options may be checked in encoder. Otherwise, they may be skipped. Alpha could be any positive real number such as 0.7, 1, 1.25, 1.73, . . . , and cost_t may be the best non affine cost, or the N'th best cost, where N may be any integer number such as 5, 10.

### On Step Size of MMVD and Additional Directions

26. It is proposed the initial step size may depend on the video resolution.
   a. In one example, the initial step size of the videos with width*height>C may be N times of the initial step size of the videos with width*height<=C, where C could be any integer number such as 10\hat{ }5, or any other numbers, and N may be any numbers such as 2, 4, . . .
   b. In one example there may be several thresholds for deciding the initial step size of MMVD. For example, for videos with width*height>C1 the initial step size would be L1. Otherwise for videos with width*height>C2 the initial step size would be L2. Otherwise for videos with width*height>C3 the initial step size would be L3, and so on, where C1>C2> . . . and L1>L2> . . . may be any integers.
   c. In one example, the initial step size may be signaled by or derived from at least one syntax element, such as in SPS/PPS/picture header/slice header/tile/CTU/etc.
27. It is proposed the initial step size may depend on the delta POC.
   a. In one example initial step size for blocks with delta POC>C may be N times the initial step size for blocks with delta POC<=C.
      i. In one example C may be 2 or 4 or any other integer number.
      ii. In one example N may be 2, 3 or any other integer number.
   b. Delta POC may be calculated as the absolute difference between POC of the current picture and the reference picture.
28. It is proposed the number of directions may depend on the step size.
   a. In one example the smallest step size, may have N1 directions and the remaining step sizes may have N2 directions, where N1 and N2 may be any integers. One example would be N1=8 and N2=16.
   b. In one example for the first 2 smallest step size, may have N1 directions and the remaining step sizes may have N2 directions, where N1 and N2 may be any integers. One example would be N1=8 and N2=16.
   c. In one example for the first M (e.g., M≥1) smallest step size, may have N1 directions and the remaining step sizes may have N2 directions, where N1 and N2 may be any integers. One example would be N1=8 and N2=16.

### On MMVD Flag Coding

29. It is proposed MMVD flag or affine MMVD flag may be coded with at least one context (the context index may be denoted as “ctx”).
   a. In one example, ctx may depend on information (such as coding mode/block dimensions etc.) parsed before paring the current MMVD flag or affine MMVD flag.
   b. In one example the ctx may depend on the MMVD flag of at least one neighboring block.
      i. In one example if at least one of the above or left block of current block uses MMVD, the ctx would be 1, otherwise the ctx would be 0.
      ii. In one example if both above and left block of current block uses MMVD, the ctx would be 2. If at only one of the above or left block of current block uses MMVD, the ctx would be 1, otherwise the ctx would be 0.
   c. In one example the ctx may depend on the skip flag of the current block.
      i. In one example if the current block is skip the ctx would be 0 or 1, otherwise the ctx would be 1 or 0.
   d. In one example the ctx may depend on the prediction direction of the current block.
      i. In one example if the current block is uni-prediction, the ctx would be 0, otherwise if it is bi-prediction the ctx would be 1.
   e. In one example any combination of the above scenarios may be applied, and several possible ctx may be available.
   f. Alternatively, MMVD flag or affine MMVD flag may be bypass coded.

### On MMVD Initial Base Position Update

30. It is proposed that the initial position of the MMVD (and/or affine MMVD and/or GPM with MVD and/or IBC MMVD) may be updated with Template Matching (TM).
   a. In one example a diamond shape position around initial base, with N pixel distance may be searched to find a position with lower TM cost. N could be any rational number such as 64, 16, 1, ½, ⅛, . . .
      i. In one example only one iteration is applied.
      ii. In one example more than one iteration may be applied.
      iii. In another example the iteration may continue till there is no change in the centroid.
   b. In one example the search may start at N1 pixel distance, and it could continue to smaller pixel distance.
      i. In one example first round starts by N1 pixel distance. After 1, or K1 (or until it stabilizes) iteration with N1 distance, the second round with N2 pixel distance from new center will start. It could continue for 1, K2, . . . iterations. N1 and N2 could be any rational number, and K1, K2 could be any integer.
      ii. In one example J rounds with pixel sizes N1, . . . , NJ with K1, . . . , KJ iterations may be applied, similar to part i.
   c. In one example new centroid may be updated if it has TM cost less than C*BestCost.
   d. In one example, the search process may be terminated based on a rule.
      i. For example, the search process may be terminated if the TM cost in consideration is lower or no larger than a threshold.
      ii. For example, the search process may be terminated if the number of searched points is more or no less than a threshold.

### On Extended MMVD for Bi Prediction Derivation

31. It is proposed that the MMVD (and affine MMVD) bi prediction candidate derivation may or may not apply one or multiple specific operation(s) to derive MV for at least one reference list, such asscaling, mirroring, . . .
   a. In one example if the POC difference for list 0 and list 1 is different there may be scaling for the MVD value being added to list with smaller POC difference.
      i. Alternatively, there may be no scaling involved regardless of the POC difference for each list.
   b. In one example if the ref picture for each list is on the opposite side of the current picture, a negative sign may be added to the MVD of the second list.
      i. Alternatively, there may be no mirroring involved regardless of the position of the ref pictures.

### On Extended Bi Prediction Cost Calculation and Buffer Usage

32. It is proposed that the cost calculation and prediction for some of MMVD (and affine MMVD) candidates may be stored and reused for the future candidates.
   a. In one example the prediction for one sided bi-prediction MMVD (or affine MMVD) may be stored and later reused for the two sided bi-prediction.
   b. In another example the prediction for two sided bi-prediction MMVD (or affine MMVD) may be stored and later reused for the one sided bi-prediction.

### On MMVD (or Affine MMVD, or IBC MMVD) Base Candidates

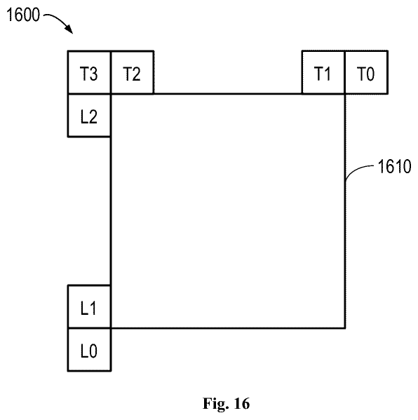

33. It is proposed that the number of the base candidates may be increased for MMVD (or affine MMVD, or IBC MMVD) depending on the coding information received before decoding the current block.
a. In one example the number of the base candidates may depend on the affine flag of parent CU.
b. In one example the number of the base candidates may depend on the best parent CU affine (or MMVD, or affine MMVD) flag.
c. In one example the number of the base candidates may depend on the neighbor blocks affine (or MMVD or affine MMVD) flag.
   i. In one example, the number of the base candidates for MMVD (or affine MMVD) may depend on the MMVD (or affine MMVD) flags of the neighbor blocks.
      (i) In one example, the neighbor blocks may be T0, and/or T1, and/or T2, and/or T3, and/or L0, and/or L1 and/or L2 (as depicted in FIG. 16).
   ii. In one example the number of the base candidate may depend on neighbor block T2 and L2 (as depicted in FIG. 16) affine (or MMVD or affine MMVD) flags.
   iii. In one example the number of the base candidate may depend on neighbor block T3 affine (or MMVD or affine MMVD) flags.
   iv. In one example the number of the base candidate may depend on neighbor block T2, T3, and L2 affine (or MMVD or affine MMVD) flags.
   v. In one example the number of the base candidate may depend on neighbor block T1 and L1 affine (or MMVD or affine MMVD) flags.
   vi. In one example the number of the base candidate may depend on neighbor block T1, T3, and L1 affine (or MMVD or affine MMVD) flags.
   vii. In one example the number of the base candidate may depend on neighbor block T0 and L0 affine (or MMVD or affine MMVD) flags.
   viii. In one example the number of the base candidate may depend on neighbor block T0, T3, and L0 affine (or MMVD or affine MMVD) flags.
   ix. In one example the number of the base candidate may depend on neighbor block T0, T1, T2, T3, L0, L1 and L2 (or any subsets of them) affine (or MMVD or affine MMVD) flags.
   d. In one example the MMVD (or affine MMVD, or IBC MMVD) base index coding may depend on the surrounding blocks.
      i. In one example, the MMVD (or affine MMVD) base index coding may depend on the MMVD (or affine MMVD) flags of the neighbor blocks.
         (i) In one example, the neighbor blocks may be TO, and/or T1, and/or T2, and/or T3, and/or L0, and/or L1 and/or L2 (as depicted in FIG. 16).
   ii. In one example the MMVD (or affine MMVD) base index coding may depend on neighbor block T2 and L2 (as depicted in FIG. 16) affine (or MMVD or affine MMVD) flags.
   iii. In one example the MMVD (or affine MMVD) base index coding may depend on neighbor block T3 affine (or MMVD or affine MMVD) flags.
   iv. In one example the MMVD (or affine MMVD) base index coding may depend on neighbor block T2, T3, and L2 affine (or MMVD or affine MMVD) flags.
   v. In one example the MMVD (or affine MMVD) base index coding may depend on neighbor block T1 and L1 affine (or MMVD or affine MMVD) flags.
   vi. In one example the MMVD (or affine MMVD) base index coding may depend on neighbor block T1, T3, and L1 affine (or MMVD or affine MMVD) flags.
   vii. In one example the MMVD (or affine MMVD) base index coding may depend on neighbor block T0 and L0 affine (or MMVD or affine MMVD) flags.
   viii. In one example the MMVD (or affine MMVD) base index coding may depend on neighbor block T0, T3, and L0 affine (or MMVD or affine MMVD) flags.
   ix. In one example the MMVD (or affine MMVD) base index coding may depend on neighbor block T0, T1, T2, T3, L0, L1 and L2 (or any subsets of them) affine (or MMVD or affine MMVD) flags.
   x. In one example this index may be coded as Truncated Unary, Binary, Truncated Binary, Rice code, Golomb code, Exp Golomb code, or any other code.
   xi. In one example the bins may be coded as context coded bin, or bypass coded bin, or any combination of them. The ctx may depend on the neighbor block T0, T1, T2, T3, L0, L1 and L2 (or any subsets of them).
34. It is proposed that there may be variation on MMVD (or affine MMVD, or IBC MMVD) merge list construction.
   a. In one example, only inherited affine may be allowed to be added to the affine MMVD merge list.
   b. In one example up to K inherited affine may be allowed to be to the affine MMVD merge list, and the remaining may be filled with the constructed affine candidates. K could be any integer number.
   c. In one example only constructed affine may be allowed to be added to the affine MMVD merge list.
   d. In one example uni prediction candidates may be put first in the list of the MMVD merge list.
   e. In one example up to N uni prediction candidate may be put first in the list of the MMVD merge list. N could be any integer including 0, 1, 4, . . .
   f. In one example the candidates with different reference pictures may be put first in the merge list for MMVD (and/or affine MMVD).
   g. In one example the affine candidates with similar CPMV may be skipped.
35. In one example, the shape of a template used to reorder/refine/update/derive a MMVD candidate may be the same to the template used for another coding tool (such as TM-merge), or may be different to the template used for another coding tool.

### General Aspects

36. Whether to and/or how to apply the methods described above may be dependent on coded information.
   a. In one example, the coded information may include block sizes and/or temporal layers, and/or slice/picture types, colour component, et al.
37. Whether to and/or how to apply the methods described above may be indicated in the bitstream.
   b. The indication of enabling/disabling or which method to be applied may be signalled at sequence level/group of pictures level/picture level/slice level/tile group level, such as in sequence header/picture header/SPS/VPS/DPS/DCI/PPS/APS/slice header/tile group header.
   c. The indication of enabling/disabling or which method to be applied may be signaled at PB/TB/CB/PU/TU/CU/VPDU/CTU/CTU row/slice/tile/sub-picture/other kinds of region contain more than one sample or pixel.

More details of the embodiments of the present disclosure will be described below which are related to MMVD-based coding. The embodiments of the present disclosure should be considered as examples to explain the general concepts and should not be interpreted in a narrow way. Furthermore, these embodiments can be applied individually or combined in any manner.

As used herein, the term “MMVD” may refer to a coding tool where partial of motion information (e.g., reference picture index, prediction direction from list 0 or list 1, and base motion vectors) is inherited from a candidate while indication of some additional refinement of refined motion information (e.g., refined my differences) is further signaled in the bitstream. MMVD may also comprise extensions of MMVD, e.g., the affine MMVD or GPM MMVD (GMVD), MMVD for IBC mode, MMVD for affine IBC mode. The term “block” may represent a coding tree block (CTB), a coding tree unit (CTU), a coding block (CB), a coding unit (CU), a prediction unit (PU), a transform unit (TU), a prediction block (PB), a transform block (TB), a video processing unit comprising multiple samples/pixels, and/or the like. A block may be rectangular or non-rectangular.

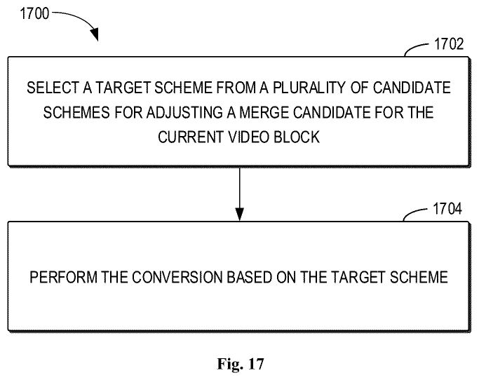

FIG. 17 illustrates a flowchart of a method 1700 for video processing in accordance with some embodiments of the present disclosure. The method 1700 may be implemented during a conversion between a current video block of a video and a bitstream of the video. As shown in FIG. 17, the method 1700 starts at 1702 where a target scheme is selected from a plurality of candidate schemes for adjusting a merge candidate for the current video block.

The plurality of candidate schemes comprise a first set of candidate schemes and/or a second set of candidate schemes. In each of the first set of candidate schemes, a first motion vector (MV) of the merge candidate is adjusted with a first motion vector difference (MVD), and a second MV of the merge candidate is kept unadjusted. In each of the second set of candidate schemes, the second MV is adjusted with a second MVD, and the first MV is kept unadjusted. Both the first set of candidate schemes and the second set of candidate schemes may be referred to as one-sided bi-prediction candidate schemes. By way of example rather than limitation, the current video block may be coded with an MMVD-based coding tool, such as an MMVD, an affine MMVD, or the like.

In some embodiments, the plurality of candidate schemes may further comprise a third set of candidate schemes. In each of the third set of candidate schemes, the first MV may be adjusted with a third MVD and the second MV may be adjusted with a fourth MVD. The third set of candidate schemes may be referred to as two-sided bi-prediction candidate schemes.

In some embodiments, the first MVD may be added to a first MVD list corresponding to the first MV, and the second MVD may be added to a second MVD list corresponding to the second MV. Additionally, the third MVD may be added to the first MVD list, and the fourth MVD may be added to the second MVD list.

In some embodiments, a template matching (TM) cost may be determined for each of the plurality of candidate schemes. In one example, a candidate scheme with the lowest TM cost may be selected as the target scheme. In another example, a candidate scheme with a TM cost smaller than a threshold may be selected as the target scheme. It should be understood that the target scheme may be selected in any other suitable manner. The scope of the present disclosure is not limited in this respect.

At 1704, the conversion may be performed based on the target scheme. By way of example rather than limitation, the merge candidate may be adjusted based on the target scheme, and the adjusted merge candidate may be used to obtain a prediction of the current video block. In one example, the conversion may include encoding the current video block into the bitstream. Alternatively or additionally, the conversion may include decoding the current video block from the bitstream. It should be understood that the above examples are described merely for purpose of description. The scope of the present disclosure is not limited in this respect.

In view of the above, one of the first and second MVs for bi-prediction of the current video block may be adjusted while the another one is kept unadjusted. In other words, the adjustment of the two MVs for bi-prediction of the current video block is decoupled. Compared with the conventional solution where the adjustment of the two MVs for bi-prediction is coupled with each other, the proposed method can advantageously make the adjustment of the merge candidate more flexible and thus improve coding efficiency and coding quality.

In some embodiments, the number of candidate schemes in the first set of candidate schemes, the number of candidate schemes in the second set of candidate schemes and the number of candidate schemes in the third set of candidate schemes may be the same. By way of example rather than limitation, the number of candidate schemes in the first set of candidate schemes may be equal to a predetermined value, such as 8 or 16. Alternatively, at least two of the following may be different from each other: the number of candidate schemes in the first set of candidate schemes, the number of candidate schemes in the second set of candidate schemes, or the number of candidate schemes in the third set of candidate schemes.

In some embodiments, the first MV may associate with a reference picture list 0 and the second MV may associate with a reference picture list 1. Alternatively, the first MV may associate with a reference picture list 1 and the second MV may associate with a reference picture list 0.

In some embodiments, a prediction of the current video block associated with the second MV may be determined for a first candidate scheme of the first set of candidate schemes. The prediction may be stored and reused for a second candidate scheme of the first set of candidate schemes.

Additionally or alternatively, the plurality of candidate schemes may comprise a third candidate scheme and a fourth candidate scheme. At least one of the following may be stored and reused for a first motion vector prediction (MVP) determined for the fourth candidate scheme: a template matching (TM) cost associated with a second MVP determined for the third candidate scheme, or a prediction of the current video block associated with the second MVP. The second MVP is the same as the first MVP. In one example, the third candidate scheme may be comprised in the first set of candidate schemes. The fourth candidate scheme may be comprised in the third set of candidate schemes. That is, in the fourth candidate scheme, the first MV may be adjusted with a third MVD and the second MV may be adjusted with a fourth MVD. In another example, the third candidate scheme may be comprised in the third set of candidate schemes, and the fourth candidate scheme may be comprised in the first set of candidate schemes.

In aid of storing and reusing the previously determined cost and prediction, it is possible to avoid duplicated calculation, and thus the coding efficiency may be further improved.

In some embodiments, the current video block is comprised in a current picture of the video. If a picture order count (POC) difference between the current picture and a first reference picture associated with the first MV is less than a POC difference between the current picture and a second reference picture associated with the second MV, an MVD for adjusting the first MV may be determined based on a first value which is obtained by scaling a predetermined MVD distance. If the POC difference between the current picture and the first reference picture is larger than the POC difference between the current picture and the second reference picture, an MVD for adjusting the second MV may be determined based on the first value.

For example, if the POC difference for list 0 and list 1 is different, a scaling operation may be performed on an MVD to be added to a list with a smaller POC difference.

In some alternative embodiments, if a POC difference between the current picture and a first reference picture associated with the first MV is less than a POC difference between the current picture and a second reference picture associated with the second MV, an MVD for adjusting the first MV may be determined based on a predetermined MVD distance. If the POC difference between the current picture and the first reference picture is larger than the POC difference between the current picture and the second reference picture, an MVD for adjusting the second MV may be determined based on the predetermined MVD distance.

That is, the scaling operation will not be performed on an MVD to be added to a list regardless of the POC difference.

In some additional or alternative embodiments, if a first reference picture associated with the first MV precedes the current picture and a second reference picture associated with the second MV follows the current picture, an MVD for adjusting the second MV may be determined based on a second value which is obtained by adding a negative sign to a predetermined MVD distance. If the first reference picture follows the current picture and the second reference picture precedes the current picture, an MVD for adjusting the first MV may be determined based on the second value. For example, if the reference picture for each list is on the opposite side of the current picture, a negative sign may be added to an MVD to be added to the list 1, i.e., a mirroring operation may be performed on the MVD.

In some embodiments, if a first reference picture associated with the first MV precedes the current picture and a second reference picture associated with the second MV follows the current picture, an MVD for adjusting the second MV may be determined based on a predetermined MVD distance. If the first reference picture follows the current picture and the second reference picture precedes the current picture, an MVD for adjusting the first MV may be determined based on the predetermined MVD distance. In other words, the mirroring operation will not be performed on an MVD to be added to a list regardless of the position of the reference picture.

According to further embodiments of the present disclosure, a non-transitory computer-readable recording medium is provided. The non-transitory computer-readable recording medium stores a bitstream of a video which is generated by a method performed by an apparatus for video processing. According to the method, a target scheme is selected from a plurality of candidate schemes for adjusting a merge candidate for a current video block of the video. The plurality of candidate schemes comprise at least one of a first set of candidate schemes and a second set of candidate schemes. In each of the first set of candidate schemes, a first motion vector (MV) of the merge candidate is adjusted with a first motion vector difference (MVD), and a second MV of the merge candidate is kept unadjusted. In each of the second set of candidate schemes, the second MV is adjusted with a second MVD, and the first MV is kept unadjusted. Moreover, the bitstream is generated based on the target scheme.

According to still further embodiments of the present disclosure, a method for storing bitstream of a video is provided. In the method, a target scheme is selected from a plurality of candidate schemes for adjusting a merge candidate for a current video block of the video. The plurality of candidate schemes comprise at least one of a first set of candidate schemes and a second set of candidate schemes. In each of the first set of candidate schemes, a first motion vector (MV) of the merge candidate is adjusted with a first motion vector difference (MVD), and a second MV of the merge candidate is kept unadjusted. In each of the second set of candidate schemes, the second MV is adjusted with a second MVD, and the first MV is kept unadjusted. Moreover, the bitstream is generated based on the target scheme, and the bitstream is stored in a non-transitory computer-readable recording medium.

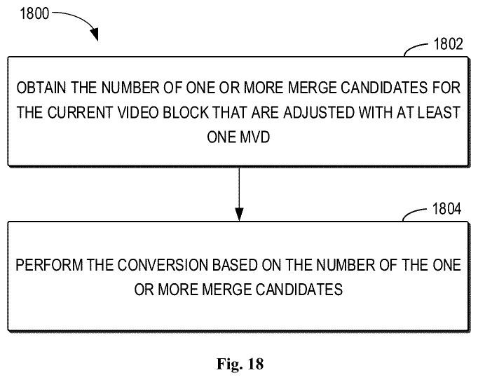

FIG. 18 illustrates a flowchart of another method 1800 for video processing in accordance with some embodiments of the present disclosure. The method 1800 may be implemented during a conversion between a current video block of a video and a bitstream of the video. As shown in FIG. 18, the method 1800 starts at 1802 where the number of one or more merge candidates for the current video block that may be adjusted with at least one MVD is obtained. As used herein, a merge candidate adjusted with an MVD may be referred to as a base candidate. The number of the one or more base candidates is dependent on coding information of one or more further video blocks of the video. The one or more further video blocks are different from the current video block.

In some embodiments, the number of the one or more merge candidates may be determined at an encoder. At a decoder, the number of the one or more merge candidates may be obtained from the bitstream. By way of example rather than limitation, the number itself or an indication of the number may be signaled in the bitstream. In some alternative embodiments, at the encoder and the decoder, the number of one or more merge candidates may be determined based on the coding information of the one or more further video blocks.

In some embodiments, the coding information may comprise: a first indication indicating whether an affine mode may be used, a second indication indicating whether an MMVD may be used, a third indication indicating whether an affine MMVD may be used, a block size, a quantization parameter, and/or the like. By way of example rather than limitation, the first indication may be an affine flag. The second indication may be an MMVD flag. The third indication may be an affine MMVD flag.

At 1804, the conversion is performed based on the number of the one or more merge candidates. In one example, the conversion may include encoding the current video block into the bitstream. Alternatively or additionally, the conversion may include decoding the current video block from the bitstream. It should be understood that the above examples are described merely for purpose of description. The scope of the present disclosure is not limited in this respect.

In view of the above, the number of base candidates for the current video block is variable rather than being fixed. Compared with the conventional solution where this number is fixed, the proposed method can advantageously make an MMVD-based coding tool more flexible and thus improve coding efficiency and coding quality.

In some embodiments, the one or more further video blocks may comprise a parent video block of the current video block. The current video block is comprised in the parent video block. For example, in a coding tree, a node corresponding to the parent video block may be a parent node of a node corresponding to the current video block. In other words, the current video block is obtained by partitioning the parent video block.

In some alternative embodiments, the one or more further video blocks may comprise a target ancestor video block of a plurality of ancestor video blocks of the current video block. The current video block is comprised in each of the plurality of ancestor video blocks. A rate-distortion (RD) cost of the target ancestor video block may be the smallest among the plurality of ancestor video blocks. For example, in a coding tree, a node corresponding to each of the plurality of ancestor video blocks may be an ancestor node of a node corresponding to the current video block. In other words, the current video block is obtained by partitioning each of the plurality of ancestor video blocks.

In some additional or alternative embodiments, the one or more further video blocks may comprise at least one neighboring video block of the current video block. By way of example rather than limitation, the at least one neighboring video block may comprise at least one of the following blocks: (1) a top left neighboring video block of the current video block, (2) a top right neighboring video block of the current video block, (3) a bottom left neighboring video block of the current video block, (4) a first left neighboring video block of the current video block, the first left neighboring video block is above the bottom left neighboring video block and below the top left neighboring video block, (5) a second left neighboring video block of the current video block, the second left neighboring video block is above the first left neighboring video block and below the top left neighboring video block, (6) a first top neighboring video block of the current video block, the first top neighboring video block is on a left side of the top right neighboring video block and on a right side of the top left neighboring video block, or (7) a second top neighboring video block of the current video block, the second top neighboring video block is on a left side of the first top neighboring video block and on a right side of the top left neighboring video block.

With reference to FIG. 16, block 1610 illustrates the current video block. Block T3 may be an example embodiment of the top left neighboring video block. Block TO may be an example embodiment of the top right neighboring video block. Block L0 may be an example embodiment of the bottom left neighboring video block. Block L1 may be an example embodiment of the first left neighboring video block. Block L2 may be an example embodiment of the second left neighboring video block. Block T1 may be an example embodiment of the first top neighboring video block. Block T2 may be an example embodiment of the second top neighboring video block. It should be understood that the above illustrations and/or examples are described merely for purpose of description. The scope of the present disclosure is not limited in this respect.

It should be understood that the one or more further video blocks may comprise any other suitable block(s). The scope of the present disclosure is not limited in this respect.

In some embodiments, an index of a first merge candidate of the one or more merge candidates may be coded based on the coding information of the at least one neighboring video block of the current video block. In one example, the index may be coded as a truncated unary code, a binary code, a truncated binary code, a Rice code, a Golomb code, an exponential Golomb code, or the like. Additionally or alternatively, a binary representation (also referred to as “bin” hereinafter) of the index may be coded as a context coded bin, a bypass coded bin, or the like. In some embodiments, a context for coding the index may be dependent on the at least one neighboring video block.

In some embodiments, a candidate list comprising the one or more merge candidates may be determined. In one example, only an inherited affine merge candidate for the current video block may be allowed to be added to the candidate list. An affine merge candidate may be extrapolated from the control point motion vectors (CPMVs) of the neighboring video block(s). Additionally or alternatively, the maximum number of inherited affine merge candidates for the current video block that are allowed to be added to the candidate list may be predetermined. By way of example rather than limitation, the maximum number may be an integer number. In another example, only a constructed affine merge candidate for the current video block may be allowed to be added to the candidate list. A constructed affine merge candidate may be derived by using translational MVs of the neighboring video blocks.

In some additional or alternative embodiments, a uni-prediction candidate for the current video block may be added to the first position of the candidate list. Additionally or alternatively, up to N uni-prediction candidates for the current video block may be added to the first N positions of the candidate list. For example, N may be an integer, such as 0, 1, 4, etc. In some embodiments, merge candidates with different reference pictures may be added to the first M positions of the candidate list. M is equal to the number of the merge candidates.

In some embodiments, the candidate list may comprise a first affine merge candidate. If a control point motion vector (CPMV) of a second affine merge candidate is the same as the first affine merge candidate, the second affine merge candidate may not be added to the candidate list. Additionally or alternatively, If a similarity metric between a CPMV of a second affine merge candidate and a CPMV of the first affine merge candidate is larger than a threshold, the second affine merge candidate may not be added to the candidate list.

In some embodiments, the current video block may be coded with an MMVD-based coding tool. By way of example rather than limitation, the MMVD-based coding tool may be an MMVD, an affine MMVD, an intra block copy (IBC) MMVD, a geometric partitioning mode (GPM) with MVD, or the like.

In some embodiments, a shape of a template used for a coding tool other than the MMVD-based coding tool may be the same as at least one of the following: a shape of a template used for reordering MMVD candidates for the current video block, a shape of a template used for refining an MMVD candidate for the current video block, a shape of a template used for updating an MMVD candidate for the current video block, a shape of a template used for determining an MMVD candidate for the current video block.

In some alternative embodiments, a shape of a template used for a coding tool other than the MMVD-based coding tool may be different from at least one of the following: a shape of a template used for reordering MMVD candidates for the current video block, a shape of a template used for refining an MMVD candidate for the current video block, a shape of a template used for updating an MMVD candidate for the current video block, a shape of a template used for determining an MMVD candidate for the current video block.

In some embodiments, at 1704, a first position of a first merge candidate of the one or more merge candidates may be updated based on template matching (TM). Moreover, the conversion may be performed based on the updated first position.

In some embodiments, the first position may be set as a reference position. The following may be performed iteratively at least one time: determining TM costs for the reference position and a set of candidate positions associated with the reference position; and if a candidate position of the set of candidate positions which has the lowest TM cost is different from the reference position, updating the reference position with the candidate position. If the candidate position which has the lowest TM cost is the same as the reference position, which indicates that the searching result is stabilized, this iteration process may be terminated, and the first position may be updated with the reference position.

In some alternative embodiments, the first position may be set as a reference position. The following may be performed iteratively at least one time: determining TM costs for the reference position and a set of candidate positions associated with the reference position; and if the TM cost of a candidate position of the set of candidate positions may be lower than a threshold, updating the reference position with the candidate position. If TM costs of all candidate positions in the set of candidate positions is no lower than the threshold, which indicates that the searching result is stabilized, this iteration process may be terminated, and the first position may be updated with the reference position.

For example, the threshold may be dependent on the TM cost of the reference position. By way of example rather than limitation, the threshold may be determined to be a production of a scaling parameter and the TM cost of the reference position. In one example, the scaling parameter may be less than 1. More specially, the scaling parameter may be 0.95. It should be understood that the above examples are described merely for purpose of description. The scope of the present disclosure is not limited in this respect.

In some embodiments, a distance between the reference position and each of the set of candidate positions may be equal to a predetermined value. By way of example rather than limitation, the predetermined value may be 64 pixels, 16 pixels, 1 pixel, ½ pixel, ⅛ pixel, or the like.

In some further alternative embodiments, a J-round searching process may be performed, where J is an integer, such as 2, 3, 5, etc. More specifically, the following may be performed iteratively at least one time for each of J rounds: determining TM costs for the reference position and a set of candidate positions associated with the reference position; and if a candidate position of the set of candidate positions which has the lowest TM cost may be different from the reference position, updating the reference position with the candidate position. For each of J rounds, a distance between the reference position and each of the set of candidate positions may be equal to a predetermined value corresponding to the respective round. If the candidate position which has the lowest TM cost is the same as the reference position, which indicates that the searching result for this round is stabilized, this searching round may be terminated, and next searching round may be started. After all of the J rounds are performed, the first position may be updated with the reference position.

In some embodiments, the distance may be equal to a first predetermined value in a first round of the J rounds, and the distance may be equal to a second predetermined value in a second round of the J rounds. The second round is performed after the first round, and the second predetermined value may be smaller than the first predetermined value. In other words, the searching round may start with a larger distance, and it could continue to smaller distance.

In some embodiments, the set of candidate positions may comprise at least one of the following: a position above the reference position, a position below the reference position, a position on a left side of the reference position, or a position on a right side of the reference position. When the set of candidate positions comprise all of the above-mentioned positions, they may also be referred to as diamond shape positions.

In some embodiments, the iteratively performing may be terminated based on a termination rule. In one example, the iteratively performing may be terminated after performing a predetermined number of times. By way of example rather than limitation, the iteratively performing may be terminated after one iteration, or three iterations. In another example, if the number of searched candidate positions is larger than or no less than a threshold, the iteratively performing may be terminated. It should be understood that the iteratively performing may be terminated based on any other suitable termination rule(s). The scope of the present disclosure is not limited in this respect.

According to further embodiments of the present disclosure, a non-transitory computer-readable recording medium is provided. The non-transitory computer-readable recording medium stores a bitstream of a video which is generated by a method performed by an apparatus for video processing. According to the method, the number of one or more merge candidates for a current video block of the video that are adjusted with at least one MVD is obtained. The number of the one or more merge candidates is dependent on coding information of one or more further video blocks of the video which are different from the current video block. Moreover, the bitstream is generated based on the number of the one or more merge candidates.

According to still further embodiments of the present disclosure, a method for storing bitstream of a video is provided. In the method, the number of one or more merge candidates for a current video block of the video that are adjusted with at least one MVD is obtained. The number of the one or more merge candidates is dependent on coding information of one or more further video blocks of the video which are different from the current video block. Moreover, the bitstream is generated based on the number of the one or more merge candidates, and the bitstream is stored in a non-transitory computer-readable recording medium.

Implementations of the present disclosure can be described in view of the following clauses, the features of which can be combined in any reasonable manner.

Clause 1. A method for video processing, comprising: selecting, for a conversion between a current video block of a video and a bitstream of the video, a target scheme from a plurality of candidate schemes for adjusting a merge candidate for the current video block; and performing the conversion based on the target scheme, wherein the plurality of candidate schemes comprise at least one of a first set of candidate schemes and a second set of candidate schemes, in each of the first set of candidate schemes, a first motion vector (MV) of the merge candidate is adjusted with a first motion vector difference (MVD), and a second MV of the merge candidate is kept unadjusted, in each of the second set of candidate schemes, the second MV is adjusted with a second MVD, and the first MV is kept unadjusted.

Clause 2. The method of clause 1, wherein the current video block is coded with a merge mode with motion vector difference (MMVD) or an affine MMVD.

Clause 3. The method of any of clauses 1-2, wherein the first MVD is added to a first MVD list corresponding to the first MV, and the second MVD is added to a second MVD list corresponding to the second MV.

Clause 4. The method of any of clauses 1-3, wherein the plurality of candidate schemes further comprise a third set of candidate schemes, in each of the third set of candidate schemes, the first MV is adjusted with a third MVD and the second MV is adjusted with a fourth MVD.

Clause 5. The method of clause 4, wherein the third MVD is added to a first MVD list corresponding to the first MV, and the fourth MVD is added to a second MVD list corresponding to the second MV.

Clause 6. The method of any of clauses 4-5, wherein the number of candidate schemes in the first set of candidate schemes, the number of candidate schemes in the second set of candidate schemes and the number of candidate schemes in the third set of candidate schemes are the same.

Clause 7. The method of clause any of clauses 1-6, wherein the number of candidate schemes in the first set of candidate schemes is equal to a predetermined value.

Clause 8. The method of any of clauses 4-5, wherein at least two of the following are different from each other: the number of candidate schemes in the first set of candidate schemes, the number of candidate schemes in the second set of candidate schemes, or the number of candidate schemes in the third set of candidate schemes.

Clause 9. The method of any of clauses 1-8, wherein the first MV associates with a reference picture list 0 and the second MV associates with a reference picture list 1, or the first MV associates with a reference picture list 1 and the second MV associates with a reference picture list 0.

Clause 10. The method of any of clauses 1-9, wherein a prediction of the current video block associated with the second MV is determined for a first candidate scheme of the first set of candidate schemes, and the prediction is stored and reused for a second candidate scheme of the first set of candidate schemes.

Clause 11. The method of any of clauses 1-10, wherein the plurality of candidate schemes comprises a third candidate scheme and a fourth candidate scheme, at least one of the following is stored and reused for a first motion vector prediction (MVP) determined for the fourth candidate scheme: a template matching (TM) cost associated with a second MVP determined for the third candidate scheme, or a prediction of the current video block associated with the second MVP, wherein the second MVP is the same as the first MVP.

Clause 12. The method of clause 11, wherein the third candidate scheme is comprised in the first set of candidate schemes, and in the fourth candidate scheme, the first MV is adjusted with a third MVD and the second MV is adjusted with a fourth MVD, or the third candidate scheme is comprised in the third set of candidate schemes, and the fourth candidate scheme is comprised in the first set of candidate schemes.

Clause 13. The method of any of clauses 1-12, wherein the current video block is comprised in a current picture of the video, if a picture order count (POC) difference between the current picture and a first reference picture associated with the first MV is less than a POC difference between the current picture and a second reference picture associated with the second MV, an MVD for adjusting the first MV is determined based on a first value, the first value being obtained by scaling a predetermined MVD distance, or if the POC difference between the current picture and the first reference picture is larger than the POC difference between the current picture and the second reference picture, an MVD for adjusting the second MV is determined based on the first value.

Clause 14. The method of any of clauses 1-12, wherein the current video block is comprised in a current picture of the video, if a POC difference between the current picture and a first reference picture associated with the first MV is less than a POC difference between the current picture and a second reference picture associated with the second MV, an MVD for adjusting the first MV is determined based on a predetermined MVD distance, or if the POC difference between the current picture and the first reference picture is larger than the POC difference between the current picture and the second reference picture, an MVD for adjusting the second MV is determined based on the predetermined MVD distance.

Clause 15. The method of any of clauses 1-14, wherein the current video block is comprised in a current picture of the video, if a first reference picture associated with the first MV precedes the current picture and a second reference picture associated with the second MV follows the current picture, an MVD for adjusting the second MV is determined based on a second value, the second value being obtained by adding a negative sign to a predetermined MVD distance, or if the first reference picture follows the current picture and the second reference picture precedes the current picture, an MVD for adjusting the first MV is determined based on the second value.

Clause 16. The method of any of clauses 1-14, wherein the current video block is comprised in a current picture of the video, if a first reference picture associated with the first MV precedes the current picture and a second reference picture associated with the second MV follows the current picture, an MVD for adjusting the second MV is determined based on a predetermined MVD distance, or if the first reference picture follows the current picture and the second reference picture precedes the current picture, an MVD for adjusting the first MV is determined based on the predetermined MVD distance.

Clause 17. A method for video processing, comprising: obtaining, for a conversion between a current video block of a video and a bitstream of the video, the number of one or more merge candidates for the current video block that are adjusted with at least one MVD, the number of the one or more merge candidates being dependent on coding information of one or more further video blocks of the video which are different from the current video block; and performing the conversion based on the number of the one or more merge candidates.

Clause 18. The method of clause 17, wherein the one or more further video blocks comprise a parent video block of the current video block, the current video block being comprised in the parent video block.

Clause 19. The method of clause 17, wherein the one or more further video blocks comprise a target ancestor video block of a plurality of ancestor video blocks of the current video block, the current video block being comprised in each of the plurality of ancestor video blocks, and a rate-distortion cost of the target ancestor video block is the smallest among the plurality of ancestor video blocks.

Clause 20. The method of any of clauses 17-19, wherein the one or more further video blocks comprise at least one neighboring video block of the current video block.

Clause 21. The method of any of clauses 17-20, wherein an index of a first merge candidate of the one or more merge candidates is coded based on coding information of at least one neighboring video block of the current video block.

Clause 22. The method of any of clauses 17-21, wherein the coding information comprises at least one of the following: a first indication indicating whether an affine mode is used, a second indication indicating whether an MMVD is used, a third indication indicating whether an affine MMVD is used, a block size, or a quantization parameter.

Clause 23. The method of clause 22, wherein the first indication is an affine flag, the second indication is an MMVD flag, or the third indication is an affine MMVD flag.

Clause 24. The method of any of clauses 20-23, wherein the at least one neighboring video block comprises at least one of the following: a top left neighboring video block of the current video block, a top right neighboring video block of the current video block, a bottom left neighboring video block of the current video block, a first left neighboring video block of the current video block, the first left neighboring video block being above the bottom left neighboring video block and below the top left neighboring video block, a second left neighboring video block of the current video block, the second left neighboring video block being above the first left neighboring video block and below the top left neighboring video block, a first top neighboring video block of the current video block, the first top neighboring video block being on a left side of the top right neighboring video block and on a right side of the top left neighboring video block, or a second top neighboring video block of the current video block, the second top neighboring video block being on a left side of the first top neighboring video block and on a right side of the top left neighboring video block.

Clause 25. The method of any of clauses 21-24, wherein the index is coded as one of the following: a truncated unary code, a binary code, a truncated binary code, a Rice code, a Golomb code, or an exponential Golomb code.

Clause 26. The method of any of clauses 21-25, wherein a binary representation of the index is coded as a context coded bin or a bypass coded bin.

Clause 27. The method of any of clauses 21-26, wherein a context for coding the index is dependent on the at least one neighboring video block.

Clause 28. The method of any of clauses 17-27, wherein the number of the one or more merge candidates is determined at an encoder, and wherein obtaining the number of one or more merge candidates comprises: obtaining the number of one or more merge candidates from the bitstream.

Clause 29. The method of any of clauses 17 and 20-21, wherein obtaining the number of one or more merge candidates comprises: determining the number of one or more merge candidates based on the coding information of the one or more further video blocks.

Clause 30. The method of any of clauses 17-29, further comprising: determining a candidate list comprising the one or more merge candidates.

Clause 31. The method of clause 30, wherein an inherited affine merge candidate for the current video block is allowed to be added to the candidate list.

Clause 32. The method of any of clauses 30-31, wherein the maximum number of inherited affine merge candidates for the current video block that are allowed to be added to the candidate list is predetermined.

Clause 33. The method of clause 32, wherein the maximum number is an integer number.

Clause 34. The method of clause 30, wherein a constructed affine merge candidate for the current video block is allowed to be added to the candidate list.

Clause 35. The method of clause 30, wherein a uni-prediction candidate for the current video block is added to the first position of the candidate list.

Clause 36. The method of clause 30, wherein up to N uni-prediction candidates for the current video block is added to the first N positions of the candidate list, and N is an integer.

Clause 37. The method of clause 30, wherein merge candidates with different reference pictures are added to the first M positions of the candidate list, and M is equal to the number of the merge candidates.

Clause 38. The method of clause 30, wherein the candidate list comprises a first affine merge candidate, if a control point motion vector (CPMV) of a second affine merge candidate is the same as the first affine merge candidate, the second affine merge candidate is not added to the candidate list.

Clause 39. The method of clause 30, wherein the candidate list comprises a first affine merge candidate, if a similarity metric between a CPMV of a second affine merge candidate and a CPMV of the first affine merge candidate is larger than a threshold, the second affine merge candidate is not added to the candidate list.

Clause 40. The method of any of clauses 17-39, wherein the current video block is coded with an MMVD-based coding tool.

Clause 41. The method of clause 44, wherein the MMVD-based coding tool comprises at least one of the following: an MMVD, an affine MMVD, an intra block copy (IBC) MMVD, or a geometric partitioning mode (GPM) with MVD.

Clause 42. The method of any of clauses 40-41, wherein a shape of a template used for a coding tool other than the MMVD-based coding tool is the same as at least one of the following: a shape of a template used for reordering MMVD candidates for the current video block, a shape of a template used for refining an MMVD candidate for the current video block, a shape of a template used for updating an MMVD candidate for the current video block, a shape of a template used for determining an MMVD candidate for the current video block.

Clause 43. The method of any of clauses 40-41, wherein a shape of a template used for a coding tool other than the MMVD-based coding tool is different from at least one of the following: a shape of a template used for reordering MMVD candidates for the current video block, a shape of a template used for refining an MMVD candidate for the current video block, a shape of a template used for updating an MMVD candidate for the current video block, a shape of a template used for determining an MMVD candidate for the current video block.

Clause 44. The method of any of clauses 17-43, wherein performing the conversion comprises: updating a first position of a first merge candidate of the one or more merge candidates based on template matching (TM); and perform the conversion based on the updated first position.

Clause 45. The method of clause 44, wherein updating the first position comprises: setting the first position as a reference position; iteratively performing the following at least one time: determining TM costs for the reference position and a set of candidate positions associated with the reference position; and if a candidate position of the set of candidate positions which has the lowest TM cost is different from the reference position, updating the reference position with the candidate position; and updating the first position with the reference position.

Clause 46. The method of clause 44, wherein updating the first position comprises: setting the first position as a reference position; iteratively performing the following at least one time: determining TM costs for the reference position and a set of candidate positions associated with the reference position; and if the TM cost of a candidate position of the set of candidate positions is lower than a threshold, updating the reference position with the candidate position; and updating the first position with the reference position.

Clause 47. The method of clause 46, wherein the threshold is dependent on the TM cost of the reference position.

Clause 48. The method of any of clauses 45-47, wherein a distance between the reference position and each of the set of candidate positions is equal to a predetermined value.

Clause 49. The method of clause 44, wherein updating the first position comprises: setting the first position as a reference position; iteratively performing the following at least one time for each of J rounds: determining TM costs for the reference position and a set of candidate positions associated with the reference position, a distance between the reference position and each of the set of candidate positions being equal to a predetermined value corresponding to the respective round; and if a candidate position of the set of candidate positions which has the lowest TM cost is different from the reference position, updating the reference position with the candidate position; and updating the first position with the reference position, wherein J is an integer.

Clause 50. The method of clause 49, wherein the distance is equal to a first predetermined value in a first round of the J rounds, the distance is equal to a second predetermined value in a second round of the J rounds, the second round is performed after the first round, and the second predetermined value is smaller than the first predetermined value.

Clause 51. The method of any of clauses 45-50, wherein the set of candidate positions comprise at least one of the following: a position above the reference position, a position below the reference position, a position on a left side of the reference position, or a position on a right side of the reference position.

Clause 52. The method of any of clauses 45-51, wherein the iteratively performing is terminated after performing a predetermined number of times.

Clause 53. The method of any of clauses 45-52, wherein if the number of searched candidate positions is larger than or no less than a threshold, the iteratively performing is terminated.

Clause 54. The method of any of clauses 1-53, wherein the conversion includes encoding the current video block into the bitstream.

Clause 55. The method of any of clauses 1-53, wherein the conversion includes decoding the current video block from the bitstream.

Clause 56. An apparatus for video processing comprising a processor and a non-transitory memory with instructions thereon, wherein the instructions upon execution by the processor, cause the processor to perform a method in accordance with any of clauses 1-16.

Clause 57. A non-transitory computer-readable storage medium storing instructions that cause a processor to perform a method in accordance with any of clauses 1-16.

Clause 58. A non-transitory computer-readable recording medium storing a bitstream of a video which is generated by a method performed by an apparatus for video processing, wherein the method comprises: selecting a target scheme from a plurality of candidate schemes for adjusting a merge candidate for a current video block of the video; and generating the bitstream based on the target scheme, wherein the plurality of candidate schemes comprise at least one of a first set of candidate schemes and a second set of candidate schemes, in each of the first set of candidate schemes, a first motion vector (MV) of the merge candidate is adjusted with a first motion vector difference (MVD), and a second MV of the merge candidate is kept unadjusted, in each of the second set of candidate schemes, the second MV is adjusted with a second MVD, and the first MV is kept unadjusted.

Clause 59. A method for storing a bitstream of a video, comprising: selecting a target scheme from a plurality of candidate schemes for adjusting a merge candidate for a current video block of the video; generating the bitstream based on the target scheme; and storing the bitstream in a non-transitory computer-readable recording medium, wherein the plurality of candidate schemes comprise at least one of a first set of candidate schemes and a second set of candidate schemes, in each of the first set of candidate schemes, a first motion vector (MV) of the merge candidate is adjusted with a first motion vector difference (MVD), and a second MV of the merge candidate is kept unadjusted, in each of the second set of candidate schemes, the second MV is adjusted with a second MVD, and the first MV is kept unadjusted.

Clause 60. A non-transitory computer-readable recording medium storing a bitstream of a video which is generated by a method performed by an apparatus for video processing, wherein the method comprises: obtaining the number of one or more merge candidates for a current video block of the video that are adjusted with at least one MVD, the number of the one or more merge candidates being dependent on coding information of one or more further video blocks of the video which are different from the current video block; and generating the bitstream based on the number of the one or more merge candidates.

Clause 61. A method for storing a bitstream of a video, comprising: obtaining the number of one or more merge candidates for a current video block of the video that are adjusted with at least one MVD, the number of the one or more merge candidates being dependent on coding information of one or more further video blocks of the video which are different from the current video block; generating the bitstream based on the number of the one or more merge candidates; and storing the bitstream in a non-transitory computer-readable recording medium.

### Example Device

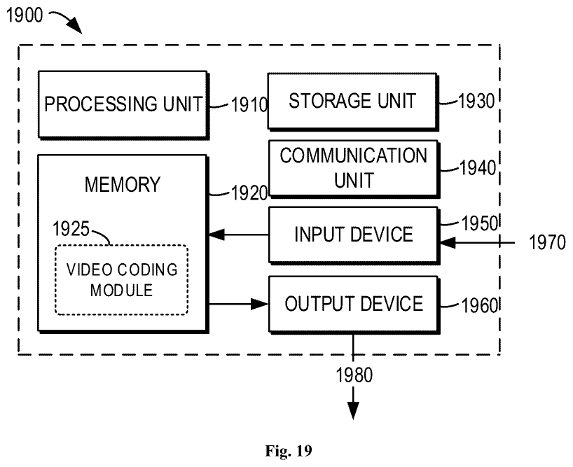

FIG. 19 illustrates a block diagram of a computing device 1900 in which various embodiments of the present disclosure can be implemented. The computing device 1900 may be implemented as or included in the source device 110 (or the video encoder 114 or 200) or the destination device 120 (or the video decoder 124 or 300).

It would be appreciated that the computing device 1900 shown in FIG. 19 is merely for purpose of illustration, without suggesting any limitation to the functions and scopes of the embodiments of the present disclosure in any manner.

As shown in FIG. 19, the computing device 1900 includes a general-purpose computing device 1900. The computing device 1900 may at least comprise one or more processors or processing units 1910, a memory 1920, a storage unit 1930, one or more communication units 1940, one or more input devices 1950, and one or more output devices 1960.

In some embodiments, the computing device 1900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1900 can support any type of interface to a user (such as “wearable” circuitry and the like).

The processing unit 1910 may be a physical or virtual processor and can implement various processes based on programs stored in the memory 1920. In a multi-processor system, multiple processing units execute computer executable instructions in parallel so as to improve the parallel processing capability of the computing device 1900. The processing unit 1910 may also be referred to as a central processing unit (CPU), a microprocessor, a controller or a microcontroller.

The computing device 1900 typically includes various computer storage medium. Such medium can be any medium accessible by the computing device 1900, including, but not limited to, volatile and non-volatile medium, or detachable and non-detachable medium. The memory 1920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1930 may be any detachable or non-detachable medium and may include a machine-readable medium such as a memory, flash memory drive, magnetic disk or another other media, which can be used for storing information and/or data and can be accessed in the computing device 1900.

The computing device 1900 may further include additional detachable/non-detachable, volatile/non-volatile memory medium. Although not shown in FIG. 19, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1940 communicates with a further computing device via the communication medium. In addition, the functions of the components in the computing device 1900 can be implemented by a single computing cluster or multiple computing machines that can communicate via communication connections. Therefore, the computing device 1900 can operate in a networked environment using a logical connection with one or more other servers, networked personal computers (PCs) or further general network nodes.

The input device 1950 may be one or more of a variety of input devices, such as a mouse, keyboard, tracking ball, voice-input device, and the like. The output device 1960 may be one or more of a variety of output devices, such as a display, loudspeaker, printer, and the like. By means of the communication unit 1940, the computing device 1900 can further communicate with one or more external devices (not shown) such as the storage devices and display device, with one or more devices enabling the user to interact with the computing device 1900, or any devices (such as a network card, a modem and the like) enabling the computing device 1900 to communicate with one or more other computing devices, if required. Such communication can be performed via input/output (I/O) interfaces (not shown).

In some embodiments, instead of being integrated in a single device, some or all components of the computing device 1900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1900 may be used to implement video encoding/decoding in embodiments of the present disclosure. The memory 1920 may include one or more video coding modules 1925 having one or more program instructions. These modules are accessible and executable by the processing unit 1910 to perform the functionalities of the various embodiments described herein.

In the example embodiments of performing video encoding, the input device 1950 may receive video data as an input 1970 to be encoded. The video data may be processed, for example, by the video coding module 1925, to generate an encoded bitstream. The encoded bitstream may be provided via the output device 1960 as an output 1980.

In the example embodiments of performing video decoding, the input device 1950 may receive an encoded bitstream as the input 1970. The encoded bitstream may be processed, for example, by the video coding module 1925, to generate decoded video data. The decoded video data may be provided via the output device 1960 as the output 1980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
selecting, for a conversion between a current video block of a video and a bitstream of the video, a target scheme from a plurality of candidate schemes for adjusting a merge candidate for the current video block; and
performing the conversion based on the target scheme,
wherein the plurality of candidate schemes comprise at least one of a first set of candidate schemes and a second set of candidate schemes,
in each of the first set of candidate schemes, a first motion vector (MV) of the merge candidate is adjusted with a first motion vector difference (MVD), and a second MV of the merge candidate is kept unadjusted,
in each of the second set of candidate schemes, the second MV is adjusted with a second MVD, and the first MV is kept unadjusted.

2. The method of claim 1, wherein the current video block is coded with a merge mode with motion vector difference (MMVD) or an affine MMVD, or
wherein the first MVD is added to a first MVD list corresponding to the first MV, and the second MVD is added to a second MVD list corresponding to the second MV.

3. The method of claim 1, wherein the plurality of candidate schemes further comprise a third set of candidate schemes, in each of the third set of candidate schemes, the first MV is adjusted with a third MVD and the second MV is adjusted with a fourth MVD.

4. The method of claim 3, wherein the third MVD is added to a first MVD list corresponding to the first MV, and the fourth MVD is added to a second MVD list corresponding to the second MV, or
wherein the number of candidate schemes in the first set of candidate schemes, the number of candidate schemes in the second set of candidate schemes and the number of candidate schemes in the third set of candidate schemes are the same, or wherein at least two of the following are different from each other: the number of candidate schemes in the first set of candidate schemes, the number of candidate schemes in the second set of candidate schemes, or the number of candidate schemes in the third set of candidate schemes.

5. The method of claim 1, wherein the number of candidate schemes in the first set of candidate schemes is equal to a predetermined value, or
wherein the first MV associates with a reference picture list 0 and the second MV associates with a reference picture list 1, or the first MV associates with a reference picture list 1 and the second MV associates with a reference picture list 0.

6. The method of claim 1, further comprising:
obtaining the number of one or more merge candidates for the current video block that are adjusted with at least one MVD, the number of the one or more merge candidates being dependent on coding information of one or more further video blocks of the video which are different from the current video block; and
performing the conversion based on the number of the one or more merge candidates.

7. The method of claim 6, wherein the one or more further video blocks comprise a parent video block of the current video block, the current video block being comprised in the parent video block, or
wherein the one or more further video blocks comprise a target ancestor video block of a plurality of ancestor video blocks of the current video block, the current video block being comprised in each of the plurality of ancestor video blocks, and a rate-distortion cost of the target ancestor video block is the smallest among the plurality of ancestor video blocks, or
wherein the one or more further video blocks comprise at least one neighboring video block of the current video block, or
wherein an index of a first merge candidate of the one or more merge candidates is coded based on coding information of at least one neighboring video block of the current video block, or
wherein the coding information comprises at least one of the following: a first indication indicating whether an affine mode is used, a second indication indicating whether an MMVD is used, a third indication indicating whether an affine MMVD is used, a block size, or a quantization parameter.

8. The method of claim 7, wherein the first indication is an affine flag, the second indication is an MMVD flag, or the third indication is an affine MMVD flag, or
wherein the at least one neighboring video block comprises at least one of the following:
a top left neighboring video block of the current video block,
a top right neighboring video block of the current video block,
a bottom left neighboring video block of the current video block,
a first left neighboring video block of the current video block, the first left neighboring video block being above the bottom left neighboring video block and below the top left neighboring video block,
a second left neighboring video block of the current video block, the second left neighboring video block being above the first left neighboring video block and below the top left neighboring video block,
a first top neighboring video block of the current video block, the first top neighboring video block being on a left side of the top right neighboring video block and on a right side of the top left neighboring video block, or
a second top neighboring video block of the current video block, the second top neighboring video block being on a left side of the first top neighboring video block and on a right side of the top left neighboring video block, or
wherein the index is coded as one of the following: a truncated unary code, a binary code, a truncated binary code, a Rice code, a Golomb code, or an exponential Golomb code, or
wherein a binary representation of the index is coded as a context coded bin or a bypass coded bin, or
wherein a context for coding the index is dependent on the at least one neighboring video block.

9. The method of claim 6, wherein the number of the one or more merge candidates is determined at an encoder, and wherein obtaining the number of one or more merge candidates comprises: obtaining the number of one or more merge candidates from the bitstream, or
wherein obtaining the number of one or more merge candidates comprises: determining the number of one or more merge candidates based on the coding information of the one or more further video blocks.

10. The method of claim 6, further comprising:
determining a candidate list comprising the one or more merge candidates.

11. The method of claim 10, wherein an inherited affine merge candidate for the current video block is allowed to be added to the candidate list.

12. The method of claim 10, wherein the maximum number of inherited affine merge candidates for the current video block that are allowed to be added to the candidate list is predetermined.

13. The method of claim 10, wherein a constructed affine merge candidate for the current video block is allowed to be added to the candidate list, or
wherein a uni-prediction candidate for the current video block is added to the first position of the candidate list, or
wherein up to N uni-prediction candidates for the current video block is added to the first N positions of the candidate list, and N is an integer, or
wherein merge candidates with different reference pictures are added to the first M positions of the candidate list, and M is equal to the number of the merge candidates, or
wherein the candidate list comprises a first affine merge candidate, if a control point motion vector (CPMV) of a second affine merge candidate is the same as the first affine merge candidate, the second affine merge candidate is not added to the candidate list, or
wherein the candidate list comprises a first affine merge candidate, if a similarity metric between a CPMV of a second affine merge candidate and a CPMV of the first affine merge candidate is larger than a threshold, the second affine merge candidate is not added to the candidate list.

14. The method of claim 6, wherein the current video block is coded with an MMVD-based coding tool.

15. The method of claim 14, wherein the MMVD-based coding tool comprises at least one of the following: an MMVD, an affine MMVD, an intra block copy (IBC) MMVD, or a geometric partitioning mode (GPM) with MVD, or
wherein a shape of a template used for a coding tool other than the MMVD-based coding tool is the same as at least one of the following:
a shape of a template used for reordering MMVD candidates for the current video block,
a shape of a template used for refining an MMVD candidate for the current video block,
a shape of a template used for updating an MMVD candidate for the current video block,
a shape of a template used for determining an MMVD candidate for the current video block, or
wherein a shape of a template used for a coding tool other than the MMVD-based coding tool is different from at least one of the following:
a shape of a template used for reordering MMVD candidates for the current video block,
a shape of a template used for refining an MMVD candidate for the current video block,
a shape of a template used for updating an MMVD candidate for the current video block,
a shape of a template used for determining an MMVD candidate for the current video block.

16. The method of claim 1, wherein the conversion includes encoding the current video block into the bitstream.

17. The method of claim 1, wherein the conversion includes decoding the current video block from the bitstream.

18. An apparatus for video processing comprising a processor and a non-transitory memory with instructions thereon, wherein the instructions upon execution by the processor, cause the processor to perform acts comprising:
selecting, for a conversion between a current video block of a video and a bitstream of the video, a target scheme from a plurality of candidate schemes for adjusting a merge candidate for the current video block; and
performing the conversion based on the target scheme,
wherein the plurality of candidate schemes comprise at least one of a first set of candidate schemes and a second set of candidate schemes,
in each of the first set of candidate schemes, a first motion vector (MV) of the merge candidate is adjusted with a first motion vector difference (MVD), and a second MV of the merge candidate is kept unadjusted,
in each of the second set of candidate schemes, the second MV is adjusted with a second MVD, and the first MV is kept unadjusted.

19. A non-transitory computer-readable storage medium storing instructions that cause a processor to perform acts comprising:
selecting, for a conversion between a current video block of a video and a bitstream of the video, a target scheme from a plurality of candidate schemes for adjusting a merge candidate for the current video block; and
performing the conversion based on the target scheme,
wherein the plurality of candidate schemes comprise at least one of a first set of candidate schemes and a second set of candidate schemes,
in each of the first set of candidate schemes, a first motion vector (MV) of the merge candidate is adjusted with a first motion vector difference (MVD), and a second MV of the merge candidate is kept unadjusted,
in each of the second set of candidate schemes, the second MV is adjusted with a second MVD, and the first MV is kept unadjusted.

20. A non-transitory computer-readable recording medium storing a bitstream of a video which is generated by a method performed by an apparatus for video processing, wherein the method comprises:
selecting a target scheme from a plurality of candidate schemes for adjusting a merge candidate for a current video block of the video; and
generating the bitstream based on the target scheme,
wherein the plurality of candidate schemes comprise at least one of a first set of candidate schemes and a second set of candidate schemes,
in each of the first set of candidate schemes, a first motion vector (MV) of the merge candidate is adjusted with a first motion vector difference (MVD), and a second MV of the merge candidate is kept unadjusted,
in each of the second set of candidate schemes, the second MV is adjusted with a second MVD, and the first MV is kept unadjusted.
